(19) United States
(12) Patent Application Publication
(10) Pub. No.: US 2026/0113151 A1
(43) Pub. Date: Apr. 23, 2026

(54) CONDITIONAL INCREASE OF NUMBER OF HARQ PROCESSES AND RELATED SIGNALING

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Wanshi CHEN, San Diego, CA (US)

(21) Appl. No.: 18/918,860

(22) Filed: Oct. 17, 2024

(51) Int. Cl. H04L 1/1812; H04B 17/309; H04W 72/1273; H04W 72/231

(52) U.S. Cl. CPC H04L 1/1812; H04B 17/346; H04W 72/1273; H04W 72/231

(57) ABSTRACT

A method for wireless communication at a user equipment (UE) and related apparatus are provided. In the method, the UE adjusts, based on a hybrid automatic repeat request (HARQ) operation mode, the maximum number of HARQ processes for at least one carrier in a group of carriers from a first number to a second number. The HARQ operation mode is based on one or more of: the number of configured physical uplink control channel (PUCCH) groups, the PUCCH condition associated with the number of configured PUCCH groups, the HARQ feedback condition, the physical downlink shared channel (PDSCH) restriction condition, or an indication in one or more of a medium access control (MAC)-control element (MAC-CE) or downlink control information (DCI) The UE further communicates with a network entity based on the second number of the maximum number of HARQ processes.

### TECHNICAL FIELD

The present disclosure relates generally to communication systems and, more particularly, to the adjustment of the number of hybrid automatic repeat request (HARQ) processes in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to adjust, based on a hybrid automatic repeat request (HARQ) operation mode, a maximum number of HARQ processes for at least one carrier in a group of carriers from a first number to a second number. The HARQ operation mode is based on one or more of: the number of configured physical uplink control channel (PUCCH) groups, the PUCCH condition associated with the number of configured PUCCH groups, the HARQ feedback condition, the physical downlink shared channel (PDSCH) restriction condition, or an indication in one or more of a medium access control (MAC)-control element (MAC-CE) or downlink control information (DCI). The at least one processor, individually or in any combination, may be further configured to communicate with a network entity based on the second number of the maximum number of HARQ processes.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to configure a UE to transmit HARQ feedback based on a HARQ operation mode for at least one carrier in one or more configured PUCCH group; and transmit, in a MAC-CE or DCI, an indication indicative of a maximum number of HARQ processes for the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example physical uplink control channel (PUCCH) group configuration in dual connectivity.

FIG. 5 is a diagram illustrating an example of non-collocated or non-coordinated multi-carrier (MC) deployment.

FIG. 6 is a diagram illustrating an example of non-collocated or non-coordinated MC deployment.

FIG. 7 is a diagram illustrating an example uplink slot in a low-band (LB) component carrier (CC) that carries uplink feedback information.

FIG. 8 is a diagram illustrating an example of the transmission of hybrid automatic repeat request-acknowledgement (HARQ-ACK) feedback of the second cell group on physical uplink control channel (PUCCH) cells.

FIG. 9A is a diagram illustrating an example of applying a new maximum number of HARQ process identifiers (IDs) indicated by a medium access control (MAC)-control element (MAC-CE) in accordance with various aspects of the present disclosure.

FIG. 9B is a diagram illustrating an example of applying a new maximum number of HARQ process IDs indicated by downlink control information (DCI) in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, the hybrid automatic repeat request (HARQ) process is a combination of high-rate forward error correction (FEC) and automatic repeat request (ARQ) error control. In HARQ, original data is encoded using FEC, with parity bits either sent immediately with the message or sent subsequently when a receiver detects errors. The FEC code may be chosen to correct an expected subset of all errors that may occur, while ARQ may be used to correct errors that are uncorrectable using the redundancy sent in the initial transmission. Hence, the HARQ process enhances the reliability and efficiency of data transmission. The number of HARQ processes that can be active at any given time is capped by a maximum limit. However, a uniform maximum limit on the number of active HARQ processes may hinder communication efficiency as it does not account for factors such as backhaul latency or the number of configured PUCCH groups. Example aspects presented herein provide methods and apparatus that adjust the maximum number of HARQ processes based on various network conditions and configurations.

Various aspects relate generally to wireless communication. Some aspects more specifically relate to the conditional adjustment of the maximum number of HARQ processes and related signaling mechanisms. In some examples, a user equipment (UE) may adjust the maximum number of HARQ processes for at least one carrier in a group of carriers from a first number to a second number based on a HARQ operation mode. The HARQ operation mode may be based on one or more of: the number of configured physical uplink control channel (PUCCH) groups, the PUCCH condition associated with the number of configured PUCCH groups, the HARQ feedback condition, the physical downlink shared channel (PDSCH) restriction condition, or an indication in one or more of a medium access control (MAC)-control element (MAC-CE) or downlink control information (DCI). The UE may further communicate with a network entity based on the second number of the maximum number of HARQ processes. In some examples, the UE may increase the maximum number of HARQ processes from the first number to the second number if the PUCCH condition has been met. In some examples, the UE may receive a switch indication to switch between a first HARQ operation mode and a second HARQ operation mode; and switch the maximum number of HARQ processes between the first number and the second number based on the switch in the HARQ operation mode between the first HARQ operation mode and the second HARQ operation mode. In some examples, the HARQ operation mode may be based on the PDSCH restriction condition, and the PDSCH restriction condition may be based on one or more of: the maximum transport block (TB) size, the maximum modulation and coding scheme (MCS), the maximum code rate, the maximum modulation order, the maximum bandwidth, the maximum number of layers, or the maximum number of carriers.

Particular aspects of the subject matter described in this disclosure can be implemented to realize one or more of the following potential advantages. In some examples, by enabling conditional increases in the number of HARQ processes based on various network conditions and configurations, such as uplink signal-to-interference-plus-noise ratio (SINR) and backhaul latency, the described techniques enhance flexibility and efficiency in managing uplink communications, thereby improving the reliability in wireless communications. In some examples, by allowing dynamic adjustment of the number of HARQ processes according to the specific PUCCH configuration (e.g., one or two configured PUCCH groups), the described techniques reduce the feedback latency and increase downlink throughput.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

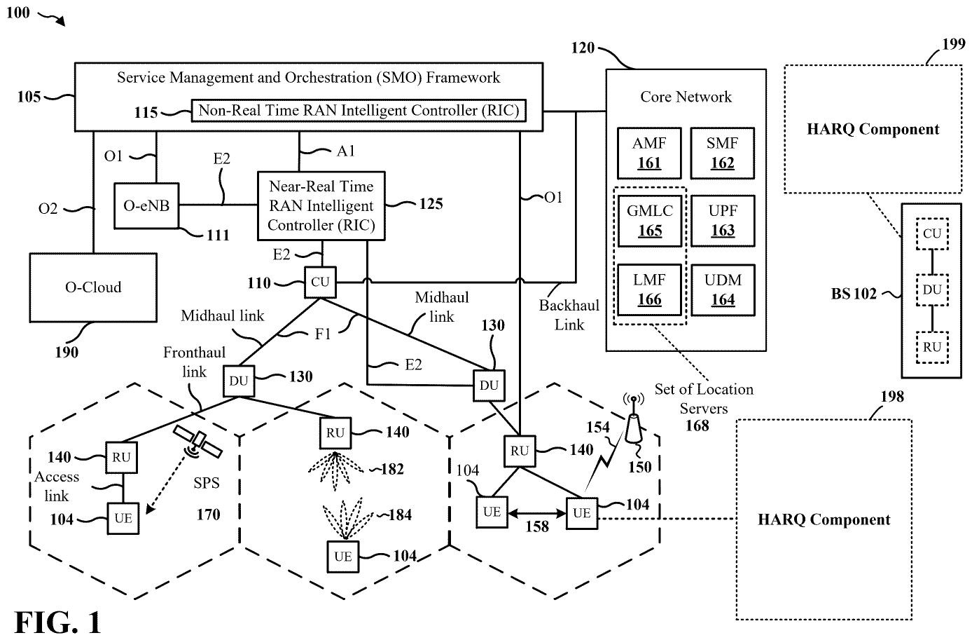

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the HARQ component 198. The HARQ component 198 may be configured to adjust, based on a HARQ operation mode, a maximum number of HARQ processes for at least one carrier in a group of carriers from a first number to a second number. The HARQ operation mode may be based on one or more of: the number of configured PUCCH groups, the PUCCH condition associated with the number of configured PUCCH groups, the HARQ feedback condition, the PDSCH restriction condition, or an indication in one or more of a MAC-CE or DCI. The HARQ component 198 may be further configured to communicate with a network entity based on the second number of the maximum number of HARQ processes. In certain aspects, the base station 102 may include the HARQ component 199. The HARQ component 199 may be configured to configure a UE to transmit HARQ feedback based on a HARQ operation mode for at least one carrier in one or more configured PUCCH group; and transmit, in a MAC-CE or DCI, an indication indicative of a maximum number of HARQ processes for the UE. Although the following description may be focused on 5G NR, the concepts described herein may be applicable to other similar areas, such as LTE, LTE-A, CDMA, GSM, and other wireless technologies.

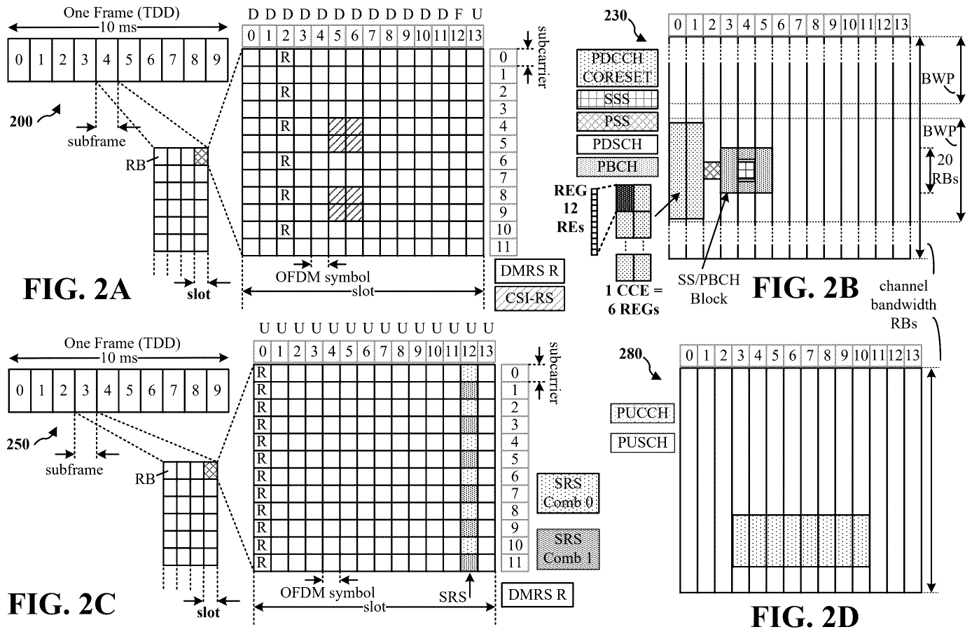

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

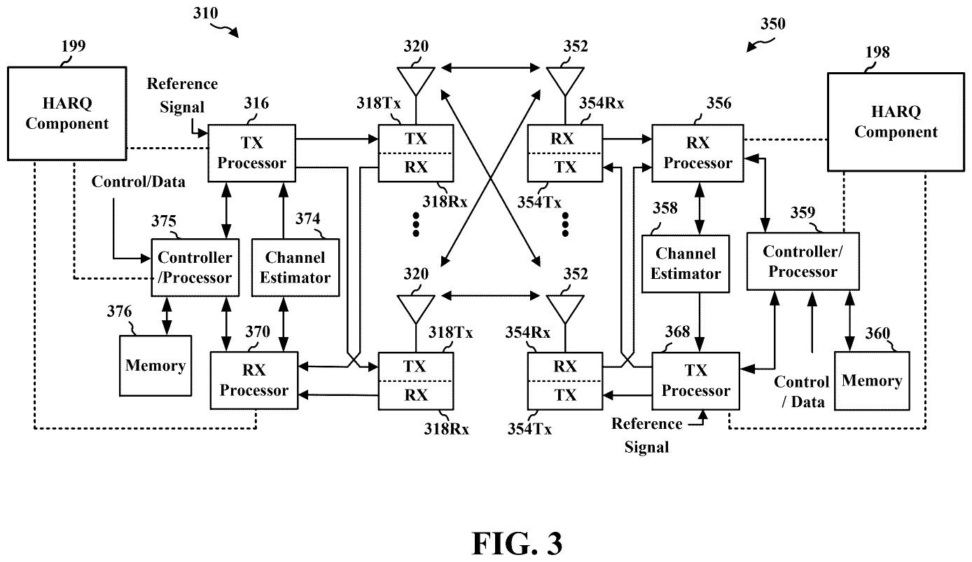

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the HARQ component 198 of FIG. 1.

At least one of the TX processor 316, the RX processor 370, and the controller/processor 375 may be configured to perform aspects in connection with the HARQ component 199 of FIG. 1.

In wireless communication, the HARQ process is a combination of high-rate FEC and ARQ error control. In HARQ, original data is encoded using FEC, with parity bits either sent immediately with the message or sent subsequently when a receiver detects errors. The FEC code may be chosen to correct an expected subset of all errors that may occur, while ARQ may be used to correct errors that are uncorrectable using the redundancy sent in the initial transmission. Hence, the HARQ process enhances the reliability and efficiency of data transmission. The number of HARQ processes that can be active at any given time is capped by a maximum limit. However, a uniform maximum limit on the number of active HARQ processes may hinder communication efficiency as it does not account for factors such as backhaul latency or the number of configured PUCCH groups. Example aspects presented herein provide methods and apparatus that adjust the maximum number of HARQ processes based on various network conditions and configurations.

The present disclosure provides methods and apparatus for conditionally increasing the maximum number of HARQ processes based on factors such as the number of PUCCH groups configured, the transport block (TB) size, modulation and coding scheme (MCS) values, maximum bandwidth (BW), and the number of layers, among others.

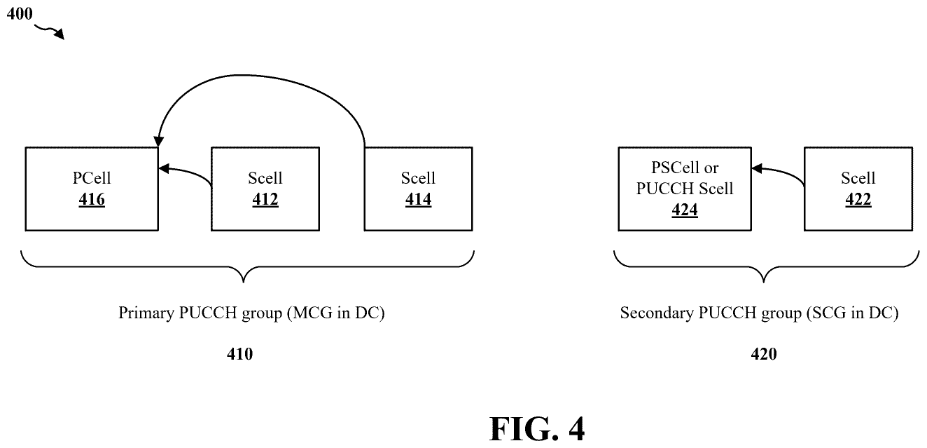

In wireless communication, the physical uplink control channel (PUCCH) can be configured in various ways within dual connectivity (DC) and carrier aggregation (CA). FIG. 4 is a diagram 400 illustrating an example PUCCH group configuration in dual connectivity. As shown in FIG. 4, in a DC configuration, two PUCCH groups, including a master cell group (MCG) 410 and a secondary cell group (SCG) 410 may be configured for a UE. The PUCCH for all component carriers (CCs) in the MCG 410, such as the primary cell (PCell) 416 and a secondary cell (SCell) 412, 414, may be transmitted on the primary cell (PCell) 416, and the PUCCH of all CCs (e.g., PSCell 424 and SCell 422) in the secondary cell group (SCG) 420 may be transmitted through the primary secondary cell (e.g., PSCell 424), which may be the primary cell of the SCG 420. In a CA configuration, in the default scenario, the PUCCH of all cells in a cell group may be transmitted on the PCell of that cell group when one PUCCH group is configured. In some examples, the configuration may be extended to include two PUCCH groups, depending on a UE capability. The cell associated with the PUCCH (e.g., referred to as “PUCCH-cell”) may be configured as part of parameter PDSCH-ServingCellConfig, which determines the serving cell index that carriers the PUCCH for this serving cell.

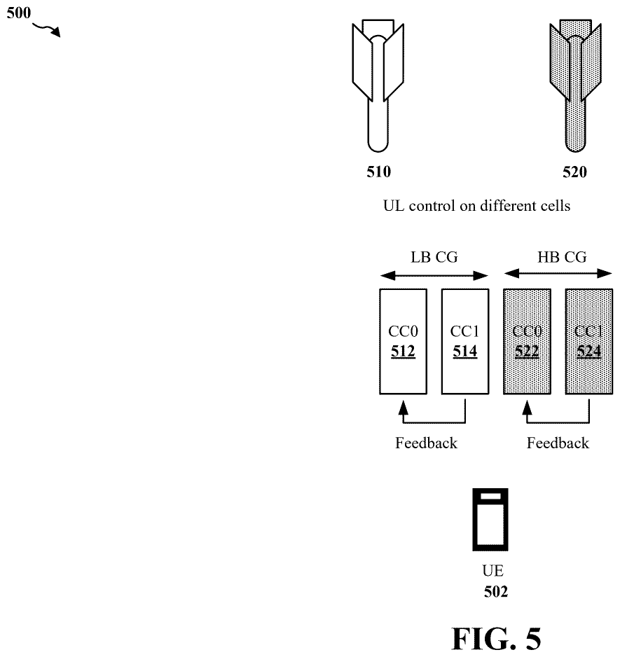

In the CA deployments, uplink (UL) coverage may vary between co-located and non-collocated deployments. Co-located deployment refers to a network deployment where multiple network elements or functionalities (e.g., multiple network cells) are located at the same physical location or in the same equipment, and non-collocated deployment (or non-coordinated deployment) refers to a network deployment where multiple network elements or functionalities (e.g., multiple network cells) are distributed across different physical locations without centralized control or coordination with each other. FIG. 5 is a diagram 500 illustrating an example of non-collocated or non-coordinated multiple-carrier (MC) deployment.

In some examples, when a CA deployment is feasible, for example, with co-located cells with a single or coordinated distribution unit (DU), such as intra-frequency range carrier aggregation (intra-FR CA), or non-collocated cells with low-latency backhaul, uplink communication may be dynamically multiplexed for all carriers on the anchor cell, which could be the PCell (e.g., PCell 416) or PUCCH-cell. This approach may help reduce the downlink/uplink imbalance by relying on a low-band (LB) coverage layer for uplink communication.

On the other hand, when a CA deployment is not feasible (e.g., when the deployment conditions for CA cannot be met due to non-collocated or non-coordinated MC deployment), dual connectivity (DC) may be employed, for example, in deployments where the frequency range 1 (FR1) and frequency range 2 (FR2) are aggregated. In DC configurations, the downlink coverage for each cell group (e.g., CC0 512, CC1 514 for cell 510, CC0 522, CC1 524 for cell 520) may be limited by its corresponding uplink coverage because uplink control messages are transmitted by UE 502 on a component carrier (CC) in the same cell group. As a result, high downlink throughput in high-band (HB) spectrum areas may be achieved when in regions with favorable coverage (e.g., when UL coverage is good enough). Therefore, enhancing uplink coverage in non-collocated deployments may help in maximizing the efficiency and reach of wireless communication. As used herein, “low-band” and “high-band” refer to specific radio frequency ranges used in wireless communication. In some examples, “low-band” may include a frequency band below 1 GHz or below 6 GHZ, and “high-band” may include a frequency band above 24 GHz or above 6 GHZ.

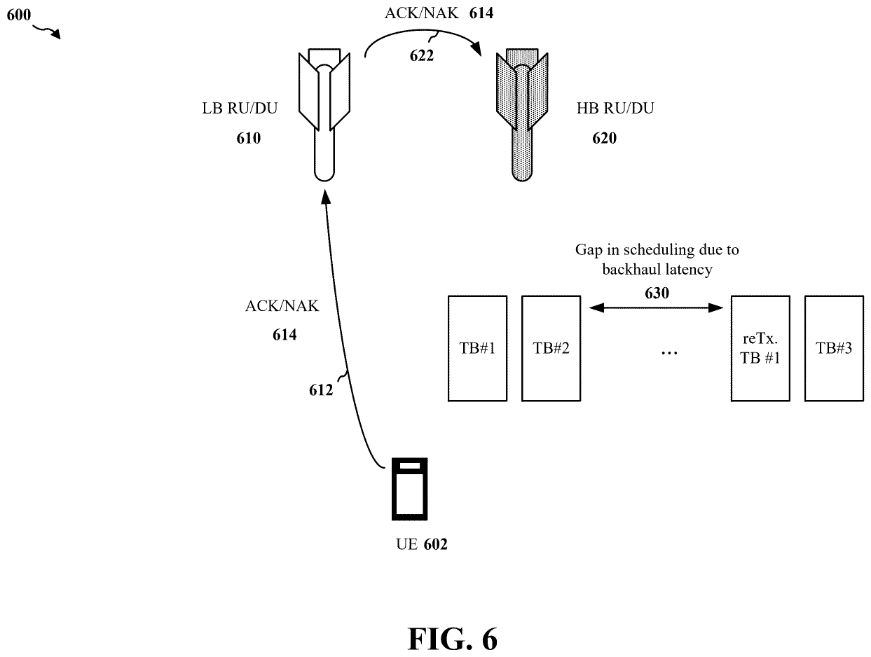

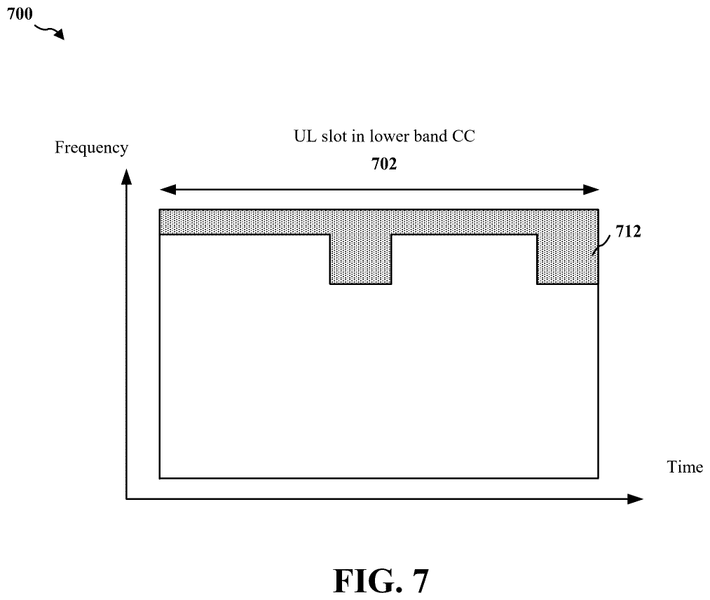

In some examples, enhancing uplink coverage for DC (or for two PUCCH groups) may involve establishing an LB anchor in non-collocated or uncoordinated multi-carrier (MC) systems. FIG. 6 is a diagram 600 illustrating an example of non-collocated or non-coordinated MC deployment. As shown in FIG. 6, in some examples, the UE 602 may transmit uplink feedback for HB (e.g., HB cell 620), including HARQ information bits and radio link control (RLC) status protocol data units (PDUs), via 612 to an LB CC (e.g., LB cell 610) with a better and more extended coverage. For example, the HARQ bits may be transmitted as group acknowledgments or negative acknowledgments (ACK/NAK) (e.g., ACK/NAK 614) and may be protected with a cyclic redundancy check (CRC) to ensure data integrity. FIG. 7 is a diagram 700 illustrating an example uplink slot in an LB CC that carries uplink feedback information. As shown in FIG. 7, some uplink resources (e.g., uplink resources 712) in an uplink slot 702 may be reserved for HB CCs. These reserved resources (e.g., uplink resources 712) may be used to carry information such as HARQ information bits.

In some examples, to optimize the use of available resources, some resources may be semi-statically reserved for the HB cell group on an LB anchor cell, such as the PCell of the MCG in a DC setting. However, the backhaul latency, such as the latency on backhaul link 622, may depend on the deployment (e.g., the distance between LB cell 610 and the HB cell 620) and interface used, which may be assumed to range between 1-20 milliseconds (ms) (typical value may be around 10 ms). Hence, increasing the number of HARQ processes to fill scheduling gaps, such as the scheduling gap 630, may not be always feasible, particularly in HB scenarios with large subcarrier spacing (SCS). This limitation also has implications for UE buffering and overall HARQ management.

In some examples, configuring the PUCCH can be done by setting up one or two PUCCH groups. In some examples, when a single PUCCH group is configured, feedback for all the downlink CCs may be transmitted via the PUCCH of the primary cell (PCell). In this configuration, the PCell may be the CC with the lower band, which may provide better uplink coverage. For example, in a deployment that includes FR1 and FR2, the PCell may be in FR1. In a deployment that includes two FR1 (e.g., an FR1+FR1 deployment), the PCell may be in the frequency range below 1 GHz while the secondary cell (Scell) may operate in the frequency range above 3.5 GHZ. However, in non-collocated or uncoordinated MC systems, the backhaul latency (e.g., the latency on the backhaul link 622) may impact the HARQ round-trip time (RTT), affecting how soon a HARQ ID can be reused.

In some examples, when two PUCCH groups are configured, the DL CCs may belong to either the first or second PUCCH group and the feedback may be transmitted via the corresponding PUCCH cell. This configuration may reduce the latency for HARQ feedback, resulting in a smaller HARQ RTT since the feedback does not need to go through backhaul connections between LB RU/DU and HB RU/DU, such as the backhaul link 622. However, in this configuration, the coverage of the PUCCH secondary cell (or PSCell in DC) may be limited, for example, when it is located in a higher frequency range such as FR2.

In some examples, when two PUCCH groups have been configured, the DL throughput of the second cell group may not be impacted by backhaul latency. However, it is susceptible to variations in the uplink signal-to-interference-plus-noise ratio (SINR) of the second cell group. On the other hand, in scenarios where one PUCCH group has been configured, the DL throughput of the second cell group may be impacted by backhaul latency, because the HARQ identifiers (IDs) cannot be used to schedule the physical downlink shared channel (PDSCH) until after the feedback has been received over the backhaul. Depending on the network implementation, this feedback reception time may be affected by backhaul latency (e.g., on interfaces between DUs or CUs) and fronthaul latency (e.g., on interfaces between DU and RU), which may be generally referred to as “coordination latency.” Increasing the number of HARQ process IDs may mitigate this issue. However, this may also introduce additional complexity and increase the memory consumption at the UE.

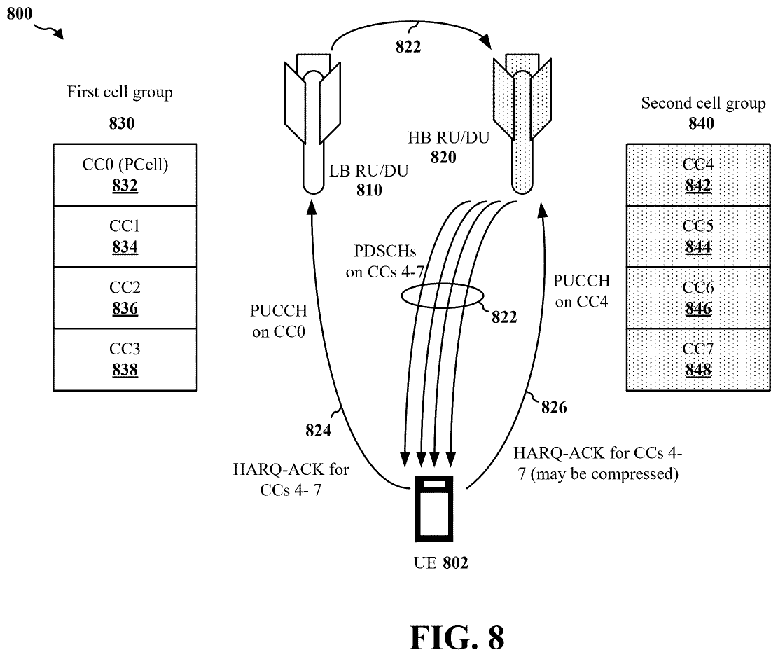

In some examples, HARQ-ACK feedback of the second cell group (e.g., an HB group) may be transmitted using PUCCH cells on both LB and HB. FIG. 8 is a diagram 800 illustrating an example of the transmission of HARQ-ACK feedback of the second cell group on PUCCH cells. As shown in FIG. 8, the HARQ-ACK feedback of the second cell group (e.g., cell group 840, which includes CC4 842, CC5 844, CC6 846, and CC7 848) may be transmitted using PUCCH cells on LB (e.g., LB cell 810) and HB (e.g., HB cell 820). This approach leverages the low latency advantages of the HB (e.g., HB cell 820) while using the LB (e.g., LB cell 810) as a reliable backup (e.g., the feedback via uplink 824 and backhaul link 822) if the HARQ-ACK feedback on the HB (e.g., the feedback via 826) fails to decode. Additionally, the feedback sent over the HB (e.g., the feedback via 826) may be compressed to increase the chance of successful decoding. In this approach, similar to configurations with a single PUCCH group, the DL throughput may be affected by the backhaul latency (e.g., the latency on backhaul link 822) and the number of HARQ process IDs. For example, if feedback transmitted to the HB (e.g., the feedback via 826) is not decoded or if the compression is lossy, the feedback may still be transmitted via the LB RU/DU (e.g., LB cell 810) over the backhaul (e.g., backhaul link 822), which may impact the throughput.

In some examples, to minimize the impact on the downlink throughput, the number of HARQ process IDs may be adjusted based on the deployment scheme and the uplink SINR of the HB (e.g., HB cell 820). For example, a higher number of HARQ process IDs may be necessary when the UL SINR is low, such as at the edges of cell coverage areas where DL SINR, rate, and throughput are not at their peak values. This setup is beneficial as it reduces the UE's burden of managing the additional complexities associated with a higher number of HARQ process IDs at peak downlink data rates. Based on these observations, example aspects provide methods and apparatus that enable a conditional increase in the maximum number of HARQ process IDs, allowing adjustments of the maximum number of HARQ process IDs based on specific network conditions and configurations. Additionally, the example aspects further provide methods and apparatus that allow a dynamic change in the maximum number of HARQ process IDs, thereby improving flexibility and responsiveness to varying network conditions. Each HARQ process may be associated with a HARQ process ID. Therefore, the maximum number of HARQ process IDs corresponds to the maximum number of HARQ processes. Hence, “the number of HARQ process IDs,” “the number of HARQ processes,” and “the number of HARQ IDs” may be used interchangeably. Additionally, the “maximum number of HARQ processes” and the “number of maximum HARQ processes” may be used interchangeably.

In some aspects, the maximum number of HARQ process IDs that can be allocated per CC for a group of CCs (e.g., HB CCs or FR2 CCs) may depend on several factors, including the configuration of the PUCCH groups.

In some examples, the determining factor for the maximum number of HARQ process IDs may include whether one or two PUCCH groups have been configured. For example, when two PUCCH groups have been configured, including the first cell group 830 (which includes CC0 832, CC1 834, CC2 836, CC3 838) and the second cell group 840 (which includes CC4 842, CC5 844, CC6 846, CC7 848), the maximum number of HARQ process IDs does not rely on backhaul latency (e.g., the latency on backhaul link 822). Therefore, adjustments to the maximum number of HARQ process IDs may be made without considering the potential increase in HARQ RTT caused by backhaul latency. On the other hand, when one PUCCH group is configured, the maximum number of HARQ IDs may be adjusted based on the backhaul latency (e.g., the latency on backhaul link 822). For example, the maximum number of HARQ IDs may be increased to compensate for increased HARQ RTT due to backhaul latency.

The adjustment of the maximum number of HARQ process IDs based on the number of configured PUCCH groups may be implemented in various ways. In some examples, the adjustment of the maximum number of HARQ process IDs may be implemented as a restriction in wireless standards. For example, the maximum number of HARQ process IDs that can be configured for each FR2 CC may be 64 or 32 when one PUCCH group is configured for a CA that involves FR1 and FR2. For other scenarios (e.g., when two PUCCH groups have been configured), the maximum number of HARQ process IDs that can be configured for each CC may be 16.

In some examples, the adjustment of the maximum number of HARQ process IDs may be implemented based on network implementation. For example, the network may determine the maximum number of HARQ process IDs based on the number of configured PUCCH groups (e.g., one or two configured PUCCH groups) and other factors such as UL SINR, and the network may communicate this maximum number to the UE.

In some examples, the UE may switch between two predefined maximum numbers of the HARQ process IDs based on the operation mode. For example, this switch mechanism may be feasible when dynamic switching by medium access control-control element (MAC-CE) or downlink control information (DCI) is possible. In some examples, the two predefined maximum numbers (e.g., 64 and 16) may be configured through a radio resource control (RRC) message, and the selected maximum number may depend on the current operation mode. In some examples, the current operation mode may be based on the number of configured PUCCH groups. For example, the UE may be RRC configured with a first maximum number of 16 and a second maximum number of 64. The first maximum number (e.g., 16) may be associated with the first operation mode where two PUCCH groups have been configured, and the second maximum number (e.g., 64) may be associated with the second operation mode where one PUCCH group has been configured. Then, the UE may apply the first maximum number (e.g., 16) when it is in the first operation mode (e.g., when two PUCCH groups have been configured) and switch to the second maximum number (e.g., 64) when the operation mode is changed to the second operation mode (e.g., when one PUCCH group has been configured). In some examples, the UE may apply the second maximum number (e.g., 64) when it is in the second operation mode (e.g., when one PUCCH group has been configured) and switch to the first maximum number (e.g., 16) when the operation mode is changed to the first operation mode (e.g., when two PUCCH groups have been configured).

In some aspects, the determining factor for the maximum number of HARQ process IDs may include whether the HARQ-ACK feedback for this group of CCs (e.g., HB CCs or FR2 CCs) is transmitted on a CC outside of the group, such as on an LB CC or a FR1 CC. For example, referring to FIG. 8, the HARQ-ACK feedback for a group of CCs (e.g., the first cell group 840) is transmitted on a CC outside of the group, such as on an LB CC (e.g., on CC0 832 in the first cell group 830 via uplink 824), the maximum number of HARQ process IDs may be increased. By determining the maximum number of HARQ process IDs based on the transmission path of the HARQ-ACK feedback, an increased number of HARQ process IDs may be provided if the HARQ-ACK feedback for this group of CCs is transmitted on both PUCCH cells.

The adjustment of the maximum number of HARQ process IDs based on the transmission path of the HARQ-ACK feedback may be implemented in various ways. In some examples, the adjustment of the maximum number of HARQ process IDs based on the transmission path of the HARQ-ACK feedback may be implemented as a restriction in wireless standards. For example, the maximum number of HARQ process IDs that can be configured for each FR2 CC may be 64 or 32 when HARQ-ACK feedback is transmitted on a CC outside of the group of CCs, such as an FR1 CC. For other scenarios (e.g., when HARQ-ACK feedback is not transmitted on a CC outside of the group of CCs), the maximum number of HARQ process IDs that can be configured for each CC may be 16.

In some examples, the adjustment of the maximum number of HARQ process IDs based on the transmission path of the HARQ-ACK feedback may be implemented based on network implementation. For example, the network may determine that the maximum number of HARQ process IDs for the group of CCs (e.g., HB CCs or FR2 CCs) is 64 or 32 if the HARQ-ACK feedback is transmitted on a CC out of this group, such as an LB CC or FR1 CC. On the other hand, the network may determine that the maximum number of HARQ process IDs for the group of CCs (e.g., HB CCs or FR2 CCs) is 16 if the HARQ-ACK feedback is not transmitted on a CC out of this group. Then, the network may communicate the maximum number determined based on the transmission path of the HARQ-ACK feedback to the UE (e.g., UE 802).

In some examples, the UE may switch between two predefined maximum numbers of the HARQ process IDs based on the transmission path of the HARQ-ACK feedback. For example, this switch mechanism may be feasible when dynamic switching by MAC-CE or DCI is possible. In some examples, the two predefined maximum numbers (e.g., 64 and 16) may be configured through an RRC message, and the selected maximum number may depend on the current operation mode. In some examples, the current operation mode may be based on the transmission path of the HARQ-ACK feedback. For example, the UE may be RRC configured with a first maximum number of 16 and a second maximum number of 64. The first maximum number (e.g., 16) may be associated with the first operation mode when the HARQ-ACK feedback is not transmitted on a CC outside of this CC group, and the second maximum number (e.g., 64) may be associated with the second operation mode when the HARQ-ACK feedback is transmitted on a CC (e.g., an LB CC or FR1 CC) outside this CC group. Then, the UE may apply the first maximum number (e.g., 16) when it is in the first operation mode and switch to the second maximum number (e.g., 64) when the operation mode is changed to the second operation mode. In some examples, the UE may apply the second maximum number (e.g., 64) when it is in the second operation mode and switch to the first maximum number (e.g., 16) when the operation mode is changed to the first operation mode.

In some aspects, the determining factor for the maximum number of HARQ process IDs may include whether restriction conditions on the physical downlink shared channel (PDSCH) parameters have been met. In some examples, the PDSCH parameters may include one or more of: the maximum transport block (TB) size, the maximum modulation and coding scheme (MCS), which may include the maximum code rate and the maximum modulation order, the maximum bandwidth (BW), the maximum number of layers, and the maximum number of CCs. Meeting the restriction conditions on these PDSCH parameters means that the actual values of these parameters do not exceed the corresponding maximum values for these parameters.

In some examples, based on the values of these PDSCH parameters, the maximum number of HARQ process IDs may be adjusted accordingly. For example, the maximum number of HARQ process IDs may be set at 64 or 32 if the restriction conditions on the PDSCH parameters have been met (e.g., when the actual values of these parameters do not exceed the corresponding maximum). If these restriction conditions are not met, the maximum number of HARQ process IDs may be limited to a lower value (e.g., 16).

In some examples, the adjustment of the maximum number of HARQ process IDs based on the restriction conditions on the PDSCH parameters may be implemented in various ways. In some examples, the adjustment of the maximum number of HARQ process IDs based on the restriction conditions on the PDSCH parameters may be implemented as a restriction in wireless standards. For example, the maximum number of HARQ process IDs that can be configured for each FR2 CC may be 64 or 32 when the restriction conditions have been met. When the restriction conditions have not been met (e.g., when the actual value of one PDSCH parameter has exceeded the corresponding maximum value), the maximum number of HARQ process IDs that can be configured for each CC may be set to a lower value (e.g., 16).

In some examples, the adjustment of the maximum number of HARQ process IDs based on the restriction conditions on the PDSCH parameters may be implemented based on UE capability signaling. For example, the UE may report different restrictions for different maximum numbers of HARQ process IDs. For example, a maximum TB size 1 (TBS1) may correspond to a maximum of 32 HARQ IDs, and a smaller maximum TB size 2 (TBS2), which is less than TBS1, may correspond to a maximum of 64 HARQ IDs. This capability may be applicable when the network configures one PUCCH group for both groups of downlink CCs or when the network configures the HARQ-ACK feedback for this group of CCs to be transmitted on both PUCCH cells. In such cases, HARQ-ACK feedback from HB CCs or FR2 CCs might be carried on the primary cell that is an LB CC or FR1 CC (e.g., CC0 832).

In some aspects, the network may indicate the maximum number of HARQ process IDs for each CC for this group of CCs (e.g., HB CCs or FR2 CCs). In some examples, this indication may be communicated through various control mechanisms, including RRC, MAC-CE, or DCI.

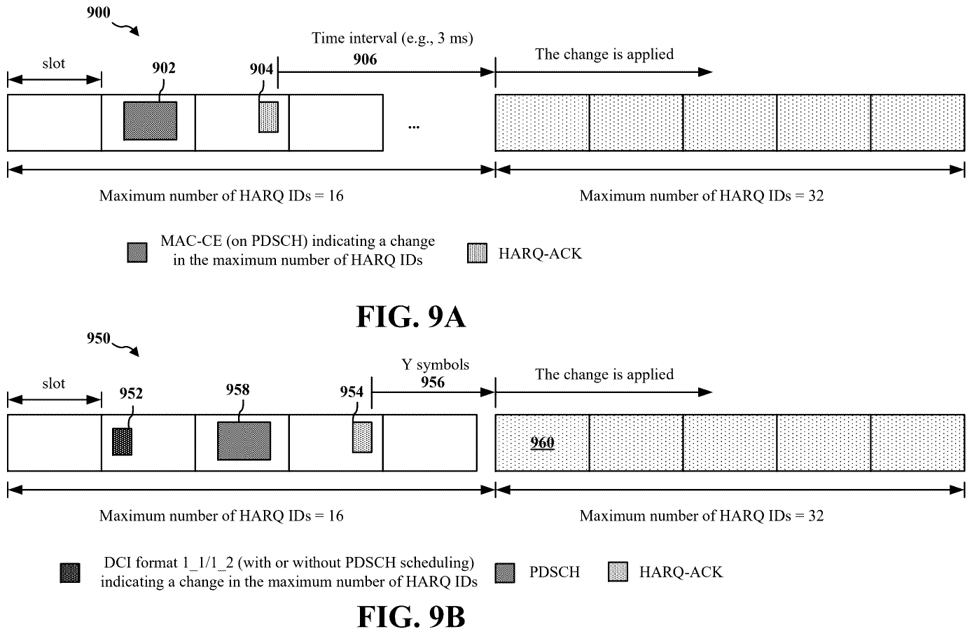

In some examples, the network may indicate a change of the maximum number of HARQ process IDs via a MAC-CE, and indication (e.g., the new maximum number of HARQ process IDs) may be applied at a time interval (e.g., 3 ms) after the transmission of HARQ-ACK in response to the PDSCH that contains this MAC-CE. FIG. 9A is a diagram 900 illustrating an example of applying a new maximum number of HARQ process IDs indicated by a MAC-CE in accordance with various aspects of the present disclosure. As shown in FIG. 9A, when the network indicates a change of the maximum number of HARQ process IDs via a MAC-CE 902, the new maximum number of HARQ process IDs may be applied at a time interval 906 after the transmission of HARQ-ACK (e.g., HARQ-ACK 904) in response to the PDSCH that contains this MAC-CE 902. Similarly, when the network indicates a change of the maximum number of HARQ process IDs via DCI, the indication (e.g., the new maximum number of HARQ process IDs) may be applied at a time interval (e.g., 3 ms) after the transmission of HARQ-ACK in response to the DCI. FIG. 9B is a diagram 950 illustrating an example of applying a new maximum number of HARQ process IDs indicated by DCI in accordance with various aspects of the present disclosure. As shown in FIG. 9B, when the network indicates a change of the maximum number of HARQ process IDs via DCI 952, the indication (e.g., the new maximum number of HARQ process IDs) may be applied at a time interval 956 after the transmission of HARQ-ACK (e.g., HARQ-ACK 954) in response to the DCI 952. In some aspects, the indication for the maximum number of HARQ process IDs (e.g., the indication via DCI 952) may be designed to be “sticky,” meaning that once the maximum number of HARQ process IDs is set, it remains effective until another DCI updates or changes this maximum number of HARQ process IDs. In some examples, the DCI (e.g., DCI 952) indicating the maximum number of HARQ process IDs may have a downlink DCI format, such as format 1_1/1_2, with a field to indicate the maximum number of HARQ process IDs. For example, the field may be a 1-bit field indicating a choice between two possible maximum numbers of HARQ process IDs (e.g., 16 or 32). In some examples, the DCI may be a scheduling DCI (e.g., DCI that schedules PDSCH). For example, the DCI 952 that indicates a new maximum number of HARQ process IDs may be a scheduling DCI that schedules PDSCH 958. In some examples, the DCI may be a non-scheduling DCI, which conveys the change in the maximum number of HARQ IDs without scheduling PDSCH. In some examples, when the DCI indicating the maximum number of HARQ process IDs is scheduling DCI, the scheduled PDSCH (e.g., PDSCH 958) may have its own HARQ process ID (which may be indicated by an existing field, such as HARQ process number (HPN)) and is not affected by this change, which may be applied after the PDSCH reception (e.g., the reception of PDSCH 958) and transmission of the HARQ-ACK feedback (e.g., HARQ-ACK 954). In some examples, when the DCI indicating the maximum number of HARQ process IDs is non-scheduling DCI, certain fields (e.g., frequency domain resource allocation (FDRA), new data indicator (NDI), or HPN) in the DCI may have a reserved value to indicate that this DCI does not schedule a PDSCH and instead indicates a change in the maximum number of HARQ IDs.

In some examples, for the indications through DCI (e.g., DCI 952) and MAC-CE (e.g., MAC-CE 902), a time interval after HARQ-ACK transmission (e.g., HARQ-ACK 904, 954) may be defined by the UE capabilities or be configured by an RRC configuration. This time interval (e.g., time interval 906 or 956) may define the timing for applying the change in the maximum number of HARQ process IDs (e.g., a change from 16 to 32). In some examples, the timing may be quantized to the slot boundary. For example, if the time interval after HARQ-ACK transmission is Y symbols after HARQ-ACK transmission (e.g., HARQ-ACK 954), the change to the maximum number of HARQ process IDs may be is applied from the first slot 960 after Y symbols after the HARQ-ACK transmission (e.g., HARQ-ACK 954). That is, at slot 960, the maximum number of HARQ process IDs is changed from 16 to 32.

In some aspects, the network may determine the operation mode (e.g., determine whether HARQ-ACK feedback for FR2 CCs should be sent to an FR1 CC) based on factors such as backhaul latency and uplink SINR, along with the UE capability. Then, the network may indicate the maximum number of HARQ process IDs based on the operation mode. For example, the network may determine the operation mode based on one or more of: whether one or two PUCCH groups have been configured, whether the HARQ-ACK feedback for this group of CCs (e.g., HB CCs or FR2 CCs) is transmitted on a CC outside of the group, such as on an LB CC or an FR1 CC, or whether restriction conditions on the PDSCH parameters have been met. In some examples, the network may also consider factors such as backhaul latency and uplink SINR, and the payload of the HARQ-ACK feedback when determining the operation mode. Based on the determined operation mode, the network may indicate the corresponding maximum number of HARQ process IDs to the UE.

In some examples, on the UE side, when there is a change in the maximum number of HARQ process IDs (e.g., a change indicated by the network) for a specific CC, the UE may flush the HARQ buffer (e.g., clear or empty the HARQ buffer) for all affected HARQ process IDs. For example, when the maximum number of HARQ process IDs is increased (e.g., from 16 to 32), this might lead to more restrictive PDSCH parameters. Hence, the UE may reallocate the memory or processes to adapt to the new limits, and the existing saved log-likelihood ratios (LLRs), which now may exceed the new parameter restrictions, may be flushed (e.g., cleared or emptied). On the other hand, when the maximum number of HARQ process IDs is decreased, for example from 32 to 16 HARQ process IDs, flushing the HARQ buffer for the remaining common process IDs (such as HPN 0-15) may not be necessary, but the IDs that are no longer usable (such as HPN 16-31) may be flushed (e.g., cleared or emptied). Following these changes, the UE may manage data transmission under the assumption that the NDI is toggled for any PDSCH scheduled after the change. Hence, only the initial transmission (Tx), but not retransmission (ReTx), is feasible the first time a given HARQ ID is used after such changes.

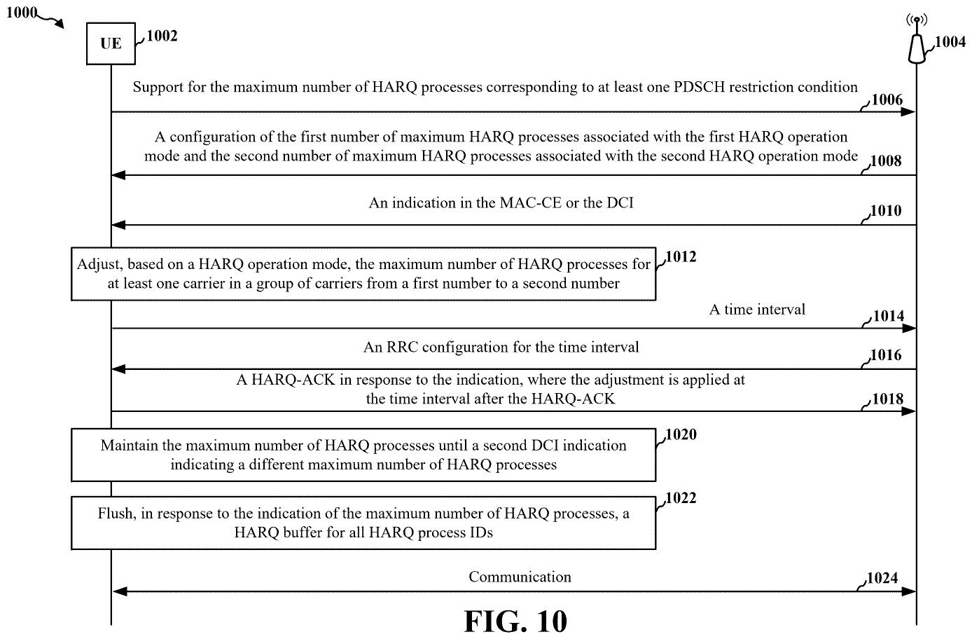

FIG. 10 is a call flow diagram 1000 illustrating a method of wireless communication in accordance with various aspects of this present disclosure. Various aspects are described in connection with a UE 1002 and a base station 1004. The aspects may be performed by the UE 1002 or the base station 1004 in aggregation and/or by one or more components of a base station 1004 (e.g., a CU 110, a DU 130, and/or an RU 140).

As shown in FIG. 10, at 1006, the UE 1002 may indicate to the base station 1004 a support for the maximum number of HARQ processes corresponding to at least one PDSCH restriction condition. In some examples, the PDSCH restriction condition may be based on one or more PDSCH parameters, including the maximum TB size, the maximum MCS, which may include the maximum code rate and the maximum modulation order, the maximum BW, the maximum number of layers, and the maximum number of CCs. For example, the UE 1002 may indicate that for a maximum TB size 1 (TBS1), the UE 1002 may support the maximum of 32 HARQ IDs, and for a smaller maximum TB size 2 (TBS2), the UE 1002 may support the maximum of 64 HARQ IDs.

At 1008, the UE 1002 may receive, from base station 1004, a configuration of the first number of maximum HARQ processes associated with the first HARQ operation mode and the second number of maximum HARQ processes associated with the second HARQ operation mode. In some examples, the HARQ operation mode may be associated with the number of configured PUCCH groups. For example, the first number of maximum HARQ processes may be 16, which is associated with the first HARQ operation mode where two PUCCH groups have been configured, and the second number of maximum HARQ processes may be 64, which is associated with the second HARQ operation mode where one PUCCH group has been configured. In some examples, the HARQ operation mode may be associated with the transmission path of the HARQ-ACK feedback. For example, the first number of maximum HARQ processes may be 16, which may be associated with the first operation mode when the HARQ-ACK feedback is not transmitted on a CC outside of the current CC group, and the second number of maximum HARQ processes may be 64, which may be associated with the second operation mode when the HARQ-ACK feedback is transmitted on a CC (e.g., an LB CC or FR1 CC) outside the current CC group. In some examples, the HARQ operation mode may be associated with whether restriction conditions on the PDSCH parameters have been met. For example, the number of maximum HARQ processes may be set at 64 or 32 if the restriction conditions on the PDSCH parameters have been met (e.g., when the actual values of these parameters do not exceed the corresponding maximum). If these restriction conditions are not met, the number of maximum HARQ process IDs may be limited to a lower value (e.g., 16).

At 1010, the UE 1002 may receive an indication in the MAC-CE or the DCI indicative of the maximum number of HARQ processes for the UE. For example, referring to FIG. 9A and FIG. 9B, the UE may receive an indication in the MAC-CE (e.g., MAC-CE 902) or the DCI (e.g., DCI 952) indicative of the maximum number of HARQ processes for the UE.

At 1012, the UE 1002 may adjust, based on a HARQ operation mode, the maximum number of HARQ processes for at least one carrier in a group of carriers from a first number to a second number. In some examples, the HARQ operation mode may be determined based on the number of configured PUCCH groups. For example, the HARQ operation mode may be determined based on whether one PUCCH group or two PUCCH groups have been configured. In some examples, the HARQ operation mode may be determined based on the transmission path of the HARQ-ACK feedback. For example, the HARQ operation mode may be determined based on whether the HARQ-ACK feedback is transmitted on a CC outside of the current CC group. In some examples, the HARQ operation mode may be determined based on whether restriction conditions on the PDSCH parameters have been met.

At 1014, the UE 1002 may transmit a time interval to the base station 1004. For example, the time interval may be time interval 906, which is an interval between the transmission of the HARQ-ACK 904 for a MAC-CE 902 indicating a change of the maximum number of HARQ IDs and the time the new maximum number of HARQ IDs is applied.

At 1016, the UE 1002 may receive an RRC configuration for the time interval from the base station 1004. For example, referring to FIG. 9B, the time interval may be time interval 956, which is an interval between the transmission of the HARQ-ACK 954 for DCI 952 indicating a change of the maximum number of HARQ IDs and the time the new maximum number of HARQ IDs is applied.

At 1018, the UE 1002 may transmit a HARQ-ACK in response to the indication, and the adjustment may be applied at the time interval after the HARQ-ACK. For example, referring to FIG. 9B, the UE may transmit a HARQ-ACK 954 in response to the indication (e.g., the indication via DCI 952), and the adjustment of the maximum number of HARQ IDs may be applied at the time interval 956 after the HARQ-ACK (e.g., HARQ-ACK 954).

At 1020, the UE 1002 may maintain the maximum number of HARQ processes until a second DCI indication indicating a different maximum number of HARQ processes. For example, referring to FIG. 9B, after the UE receiving DCI 952 indicating a maximum number of HARQ process, the UE may maintain this maximum number of HARQ processes until a second DCI indication indicating a different maximum number of HARQ processes.

At 1022, the UE 1002 may flush a HARQ buffer for all HARQ process IDs in response to the indication of the maximum number of HARQ processes. For example, the UE may flush a HARQ buffer for all HARQ process IDs in response to the indication of the maximum number of HARQ processes via MAC-CE 902 or DCI 952.

At 1024, the UE 1002 may communicate with the base station 1004 based on the indicated (e.g., indicated at 1010) or adjusted (e.g., adjusted at 1012) maximum number of HARQ processes.

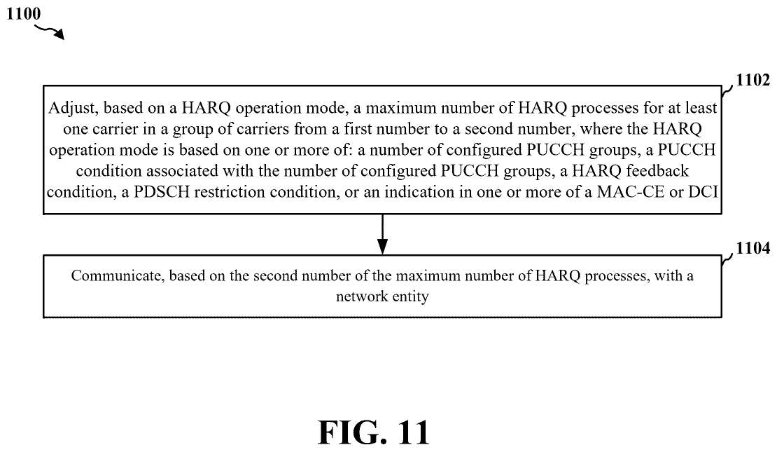

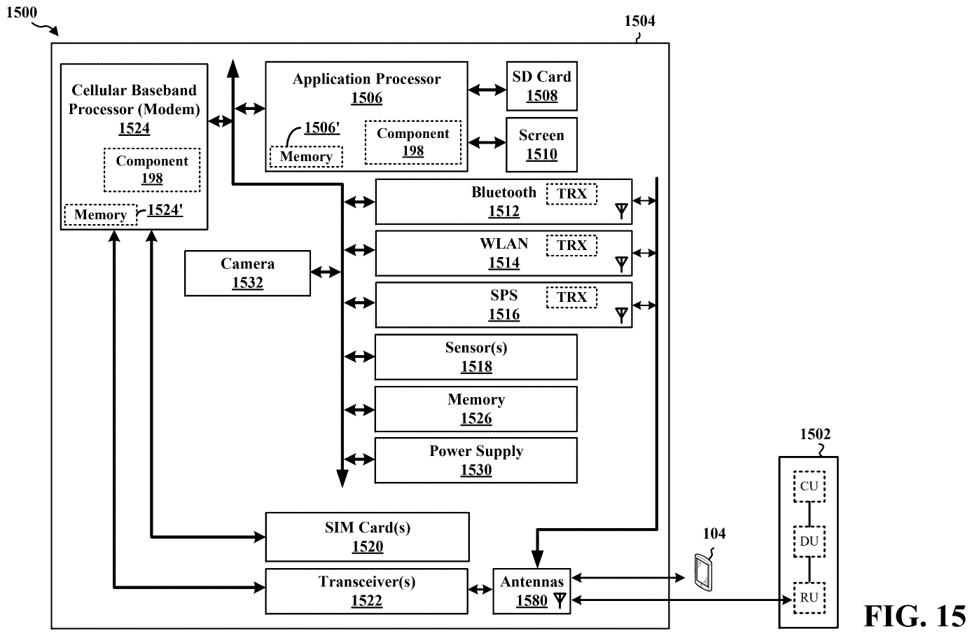

FIG. 11 is a flowchart 1100 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 802, 1002, or the apparatus 1504 in the hardware implementation of FIG. 15. By enabling conditional increases in the number of HARQ process based on various network conditions and configurations, such as uplink SINR and backhaul latency, the methods enhance flexibility and efficiency in managing uplink communications, thereby improving the reliability in wireless communications. Additionally, by allowing dynamic adjustment of the number of HARQ processes according to the specific PUCCH configuration (e.g., one or two configured PUCCH groups), the methods reduce the feedback latency and increase downlink throughput.

As shown in FIG. 11, at 1102, the UE may adjust, based on a HARQ operation mode, a maximum number of HARQ processes for at least one carrier in a group of carriers from a first number to a second number. The HARQ operation mode may be based on one or more of: a number of configured PUCCH groups, a PUCCH condition associated with the number of configured PUCCH groups, a HARQ feedback condition, a PDSCH restriction condition, or an indication in one or more of a MAC-CE or DCI. FIG. 8, FIG. 9A, FIG. 9B, and FIG. 10 illustrate various aspects of the steps in connection with flowchart 1100. For example, referring to FIG. 10, the UE 1002 may, at 1012, adjust, based on a HARQ operation mode, the maximum number of HARQ processes for at least one carrier in a group of carriers from a first number to a second number. In some examples, the HARQ operation mode may be determined based on the number of configured PUCCH groups. For example, the HARQ operation mode may be determined based on whether one PUCCH group or two PUCCH groups have been configured. In some examples, the HARQ operation mode may be determined based on the transmission path of the HARQ-ACK feedback (e.g., ACK/NAK 614). For example, the HARQ operation mode may be determined based on whether the HARQ-ACK feedback is transmitted on a CC outside of the current CC group. In some examples, the HARQ operation mode may be determined based on whether restriction conditions on the PDSCH parameters have been met. In some examples, the HARQ operation mode may be based on an indication in one or more of a MAC-CE (e.g., MAC-CE 902) or DCI (e.g., DCI 952). In some aspects, 1102 may be performed by the HARQ component 198.

At 1104, the UE may communicate with the network entity based on the second number of the maximum number of HARQ processes. For example, referring to FIG. 10, the UE 1002 may, at 1024, communicate with the network entity (e.g., base station 1004) based on the second number of the maximum number of HARQ processes. In some aspects, 1102 may be performed by the HARQ component 198.

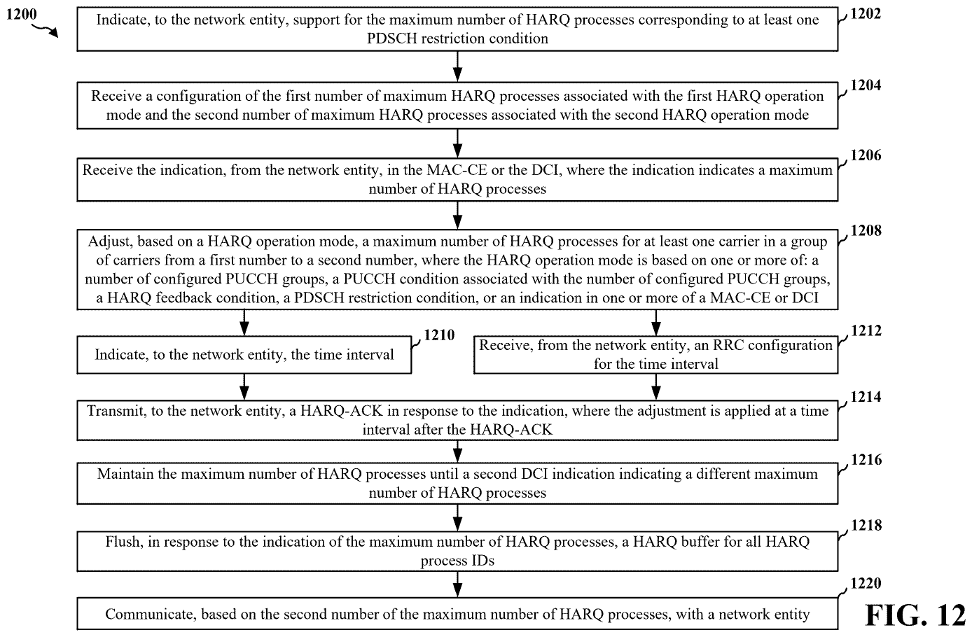

FIG. 12 is a flowchart 1200 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 802, 1002, or the apparatus 1504 in the hardware implementation of FIG. 15. By enabling conditional increases in the number of HARQ process based on various network conditions and configurations, such as uplink SINR and backhaul latency, the methods enhance flexibility and efficiency in managing uplink communications, thereby improving the reliability in wireless communications. Additionally, by allowing dynamic adjustment of the number of HARQ processes according to the specific PUCCH configuration (e.g., one or two configured PUCCH groups), the methods reduce the feedback latency and increase downlink throughput.

As shown in FIG. 12, at 1208, the UE may adjust, based on a HARQ operation mode, a maximum number of HARQ processes for at least one carrier in a group of carriers from a first number to a second number. The HARQ operation mode may be based on one or more of: a number of configured PUCCH groups, a PUCCH condition associated with the number of configured PUCCH groups, a HARQ feedback condition, a PDSCH restriction condition, or an indication in one or more of a MAC-CE or DCI. FIG. 8, FIG. 9A, FIG. 9B, and FIG. 10 illustrate various aspects of the steps in connection with flowchart 1200. For example, referring to FIG. 10, the UE 1002 may, at 1012, adjust, based on a HARQ operation mode, the maximum number of HARQ processes for at least one carrier in a group of carriers from a first number to a second number. In some examples, the HARQ operation mode may be determined based on the number of configured PUCCH groups. For example, the HARQ operation mode may be determined based on whether one PUCCH group or two PUCCH groups have been configured. In some examples, the HARQ operation mode may be determined based on the transmission path of the HARQ-ACK feedback (e.g., ACK/NAK 614). For example, the HARQ operation mode may be determined based on whether the HARQ-ACK feedback is transmitted on a CC outside of the current CC group. In some examples, the HARQ operation mode may be determined based on whether restriction conditions on the PDSCH parameters have been met. In some examples, the HARQ operation mode may be based on an indication in one or more of a MAC-CE (e.g., MAC-CE 902) or DCI (e.g., DCI 952). In some aspects, 1208 may be performed by the HARQ component 198.

At 1220, the UE may communicate with the network entity based on the second number of the maximum number of HARQ processes. For example, referring to FIG. 10, the UE 1002 may, at 1024, communicate with the network entity (e.g., base station 1004) based on the second number of the maximum number of HARQ processes. In some aspects, 1102 may be performed by the HARQ component 198.

In some aspects, the adjustment of the maximum number of HARQ processes may be based on the PUCCH condition, and the PUCCH condition may include the number of configured PUCCH groups being one. To adjust the maximum number of HARQ processes (e.g., at 1208), the UE may increase the maximum number of HARQ processes from the first number to the second number if the PUCCH condition has been met. For example, referring to FIG. 10, the adjustment of the maximum number of HARQ processes (e.g., at 1012) may be based on the PUCCH condition, and the PUCCH condition may include the number of configured PUCCH groups being one. For example, the UE 1002 may increase the maximum number of HARQ processes from the first number to the second number (e.g., from 16 to 64) if the number configured PUCCH group is one.

In some aspects, the first number of maximum HARQ processes may be defined in a wireless standard for a first HARQ operation mode and the second number of maximum HARQ processes may be defined in the wireless standard for the second HARQ operation mode. For example, the first number of maximum HARQ process (e.g., 16) may be defined in a wireless standard for a first HARQ operation mode (e.g., when two PUCCH groups have been configured) and the second number of maximum HARQ process (e.g., 64) may be defined in the wireless standard for the second HARQ operation mode (e.g., when one PUCCH group has been configured).

In some aspects, to adjust the maximum number of HARQ processes (e.g., at 1208), the UE may receive a switch indication to switch between a first HARQ operation mode and a second HARQ operation mode; and switch the maximum number of HARQ processes between the first number and the second number based on the switch in the HARQ operation mode between the first HARQ operation mode and the second HARQ operation mode. For example, referring to FIG. 10, the UE may receive a switch indication (e.g., at 1010) to switch between a first HARQ operation mode and a second HARQ operation mode; and switch the maximum number of HARQ processes between the first number and the second number based on the switch in the HARQ operation mode between the first HARQ operation mode and the second HARQ operation mode.

In some aspects, at 1204, the UE may receive, prior to the switch indication, a configuration of the first number of maximum HARQ process associated with the first HARQ operation mode and the second number of maximum HARQ process associated with the second HARQ operation mode. For example, referring to FIG. 10, the UE 1002 may, at 1008, receive a configuration of the first number of maximum HARQ process associated with the first HARQ operation mode and the second number of maximum HARQ process associated with the second HARQ operation mode. In some examples, the HARQ operation mode may be associated with the number of configured PUCCH groups. For example, the first number of maximum HARQ processes may be 16, which is associated with the first HARQ operation mode where two PUCCH groups have been configured, and the second number of maximum HARQ processes may be 64, which is associated with the second HARQ operation mode where one PUCCH group has been configured. In some examples, the HARQ operation mode may be associated with the transmission path of the HARQ-ACK feedback. For example, the first number of maximum HARQ processes may be 16, which may be associated with the first operation mode when the HARQ-ACK feedback is not transmitted on a CC outside of the current CC group, and the second number of maximum HARQ processes may be 64, which may be associated with the second operation mode when the HARQ-ACK feedback is transmitted on a CC (e.g., an LB CC or FR1 CC) outside the current CC group. In some examples, the HARQ operation mode may be associated with whether restriction conditions on the PDSCH parameters have been met. For example, the number of maximum HARQ processes may be set at 64 or 32 if the restriction conditions on the PDSCH parameters have been met (e.g., when the actual values of these parameters do not exceed the corresponding maximum). If these restriction conditions are not met, the number of maximum HARQ process IDs may be limited to a lower value (e.g., 16). In some aspects, 1204 may be performed by the HARQ component 198.

In some aspects, the switch indication may indicate a change between multiple configured PUCCH groups and a single configured PUCCH group. For example, referring to FIG. 10, the switch indication (e.g., at 1010) may indicate a change between multiple configured PUCCH groups (e.g., two configured PUCCH groups) and a single configured PUCCH group.

In some aspects, the at least one carrier may be included in the group of carriers for a configured PUCCH group, and the HARQ operation mode may be based on the HARQ feedback condition. The switch indication may indicate a change between a first transmission of HARQ feedback for the at least one carrier on a carrier outside the group of carriers for the configured PUCCH group and a second transmission of the HARQ feedback for the at least one carrier within the configured PUCCH group. For example, referring to FIG. 10, the at least one carrier may be included in the group of carriers for a configured PUCCH group, and the HARQ operation mode may be based on the HARQ feedback condition (e.g., the transmission path of the HARQ feedback). For example, the switch indication may indicate a change between a first transmission of HARQ feedback for the at least one carrier on a carrier outside the group of carriers for the configured PUCCH group (e.g., an LB CC or FR1 CC outside the group of HB CCs or FR2 CCs) and a second transmission of the HARQ feedback for the at least one carrier within the configured PUCCH group.

In some aspects, the HARQ operation mode may be based on the PDSCH restriction condition, which may include one or more of: the maximum TB size, the maximum MCS, the maximum code rate, the maximum modulation order, the maximum bandwidth, the maximum number of layers, or the maximum number of carriers. For example, the HARQ operation mode may be associated with whether restriction conditions on the PDSCH parameters have been met.

In some aspects, to adjust the maximum number of HARQ processes (e.g., at 1208), the UE may increase the maximum number of HARQ processes from the first number to the second number if the PDSCH restriction condition has been met. For example, the number of maximum HARQ processes may be set at 64 or 32 if the restriction conditions on the PDSCH parameters have been met (e.g., when the actual values of these parameters do not exceed the corresponding maximum). If these restriction conditions are not met, the number of maximum HARQ process IDs may be limited to a lower value (e.g., 16).

In some aspects, the first number is 16, and the second number is 32 or 64.

In some aspects, at 1202, the UE may indicate, to the network entity, support for the maximum number of HARQ processes corresponding to at least one PDSCH restriction condition. For example, referring to FIG. 10, the UE 1002 may, at 1006, indicate, to the network entity (e.g., base station 1004), support for the maximum number of HARQ processes corresponding to at least one PDSCH restriction condition. In some aspects, 1202 may be performed by the HARQ component 198. In some aspects, at 1206, the UE may receive the indication, from the network entity, in the MAC-CE or the DCI. The indication may indicate a maximum number of HARQ processes. To adjust the maximum number of HARQ processes (e.g., at 1208), the UE may adjust the maximum number of HARQ processes based on the indication in the MAC-CE or the DCI. For example, referring to FIG. 10, the UE 1002 may, at 1010, receive the indication, from the network entity (e.g., base station 1004), in the MAC-CE (e.g., MAC-CE 902) or the DCI (e.g., DCI 952). The indication may indicate a maximum number of HARQ processes. To adjust the maximum number of HARQ processes (e.g., at 1008), the UE 1002 may adjust the maximum number of HARQ processes based on the indication in the MAC-CE (e.g., MAC-CE 902) or the DCI (e.g., DCI 952). In some aspects, 1206 may be performed by the HARQ component 198.

In some aspects, at 12 14, the UE may transmit, to the network entity, a HARQ-ACK in response to the indication, and the adjustment may be applied at a time interval after the HARQ-ACK. For example, referring to FIG. 10, the UE 1002 may, at 1018, transmit to the network entity (e.g., base station 1004) a HARQ-ACK in response to the indication, and the adjustment may be applied at a time interval (e.g., time interval 906, 956) after the HARQ-ACK (e.g., HARQ-ACK 904, 954). In some aspects, 1214 may be performed by the HARQ component 198.

In some aspects, at 1210, the UE may indicate the time interval to the network entity. For example, referring to FIG. 10, the UE 1002 may, at 1014, indicate the time interval to the network entity (e.g., base station 1004). In some aspects, 1210 may be performed by the HARQ component 198.

In some aspects, at 1212, the UE may receive, from the network entity, an RRC configuration for the time interval. For example, referring to FIG. 10, the UE 1002 may, at 1016, receive, from the network entity (e.g., base station 1004), an RRC configuration for the time interval. In some aspects, 1212 may be performed by the HARQ component 198.

In some aspects, the indication of the maximum number of HARQ processes may be included in the DCI, and the UE may, at 1216, maintain the maximum number of HARQ processes until a second DCI indication indicating a different maximum number of HARQ processes. For example, referring to FIG. 10, the indication of the maximum number of HARQ processes may be included in the DCI (e.g., DCI 952), and the UE 1002 may, at 1020, maintain the maximum number of HARQ processes until a second DCI indication indicating a different maximum number of HARQ processes. In some aspects, 1216 may be performed by the HARQ component 198.

In some aspects, at 1218, the UE may flush, in response to the indication of the maximum number of HARQ processes, a HARQ buffer for all HARQ process IDs. For example, referring to FIG. 10, the UE 1002 may, at 1022, flush, in response to the indication of the maximum number of HARQ processes, a HARQ buffer for all HARQ process IDs. In some aspects, 1218 may be performed by the HARQ component 198.

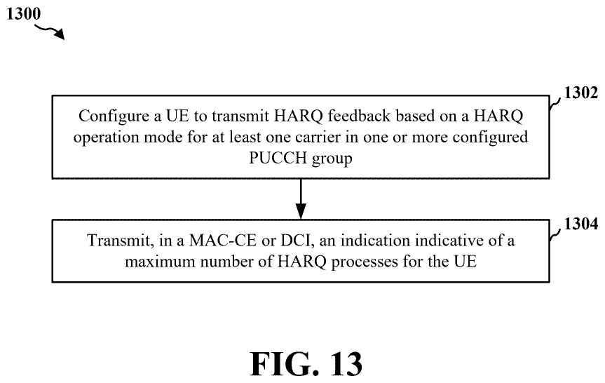

FIG. 13 is a flowchart 1300 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 802, 1002, or the apparatus 1504 in the hardware implementation of FIG. 15. By enabling conditional increases in the number of HARQ process based on various network conditions and configurations, such as uplink SINR and backhaul latency, the methods enhance flexibility and efficiency in managing uplink communications, thereby improving the reliability in wireless communications. Additionally, by allowing dynamic adjustment of the number of HARQ processes according to the specific PUCCH configuration (e.g., one or two configured PUCCH groups), the methods reduce the feedback latency and increase downlink throughput.

As shown in FIG. 13, at 1302, the network entity may configure the UE to transmit HARQ feedback based on a HARQ operation mode for at least one carrier in one or more configured PUCCH groups. FIG. 8, FIG. 9A, FIG. 9B, and FIG. 10 illustrate various aspects of the steps in connection with flowchart 1300. For example, referring to FIG. 10, the network entity (e.g., base station 1004) may, at 1008, configure the UE 1002 to transmit HARQ feedback based on a HARQ operation mode for at least one carrier in one or more configured PUCCH groups. In some aspects, 1302 may be performed by the HARQ component 199.

At 1304, the network entity may transmit, in a MAC-CE or DCI, an indication indicative of a maximum number of HARQ processes for the UE. For example, referring to FIG. 10, the network entity (e.g., base station 1004) may, at 1010, transmit, in a MAC-CE (e.g., MAC-CE 902) or DCI (e.g., DCI 952), an indication indicative of a maximum number of HARQ processes for the UE. In some aspects, 1304 may be performed by the HARQ component 199.

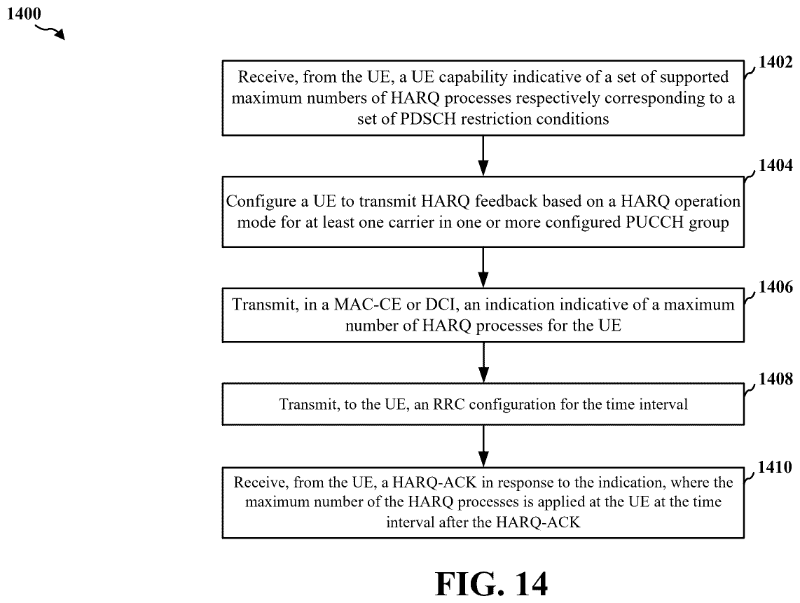

FIG. 14 is a flowchart 1400 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 802, 1002, or the apparatus 1504 in the hardware implementation of FIG. 15. By enabling conditional increases in the number of HARQ process based on various network conditions and configurations, such as uplink SINR and backhaul latency, the methods enhance flexibility and efficiency in managing uplink communications, thereby improving the reliability in wireless communications. Additionally, by allowing dynamic adjustment of the number of HARQ processes according to the specific PUCCH configuration (e.g., one or two configured PUCCH groups), the methods reduce the feedback latency and increase downlink throughput.

As shown in FIG. 14, at 1404, the network entity may configure the UE to transmit HARQ feedback based on a HARQ operation mode for at least one carrier in one or more configured PUCCH groups. FIG. 8, FIG. 9A, FIG. 9B, and FIG. 10 illustrate various aspects of the steps in connection with flowchart 1400. For example, referring to FIG. 10, the network entity (e.g., base station 1004) may, at 1008, configure the UE 1002 to transmit HARQ feedback based on a HARQ operation mode for at least one carrier in one or more configured PUCCH groups. In some aspects, 1404 may be performed by the HARQ component 199.

At 1406, the network entity may transmit, in a MAC-CE or DCI, an indication indicative of a maximum number of HARQ processes for the UE. For example, referring to FIG. 10, the network entity (e.g., base station 1004) may, at 1010, transmit, in a MAC-CE (e.g., MAC-CE 902) or DCI (e.g., DCI 952), an indication indicative of a maximum number of HARQ processes for the UE. In some aspects, 1406 may be performed by the HARQ component 199.

In some aspects, the maximum number of HARQ processes may be based on the HARQ operation mode, and the HARQ operation mode may be based on one or more of: the number of configured PUCCH groups, the PUCCH condition associated with the number of configured PUCCH groups, the HARQ feedback condition, or the PDSCH restriction condition. In some examples, the HARQ operation mode may be associated with the number of configured PUCCH groups. For example, the first number of maximum HARQ processes may be 16, which is associated with the first HARQ operation mode where two PUCCH groups have been configured, and the second number of maximum HARQ processes may be 64, which is associated with the second HARQ operation mode where one PUCCH group has been configured. In some examples, the HARQ operation mode may be associated with the transmission path of the HARQ-ACK feedback. For example, the first number of maximum HARQ processes may be 16, which may be associated with the first operation mode when the HARQ-ACK feedback is not transmitted on a CC outside of the current CC group, and the second number of maximum HARQ processes may be 64, which may be associated with the second operation mode when the HARQ-ACK feedback is transmitted on a CC (e.g., an LB CC or FR1 CC) outside the current CC group. In some examples, the HARQ operation mode may be associated with whether restriction conditions on the PDSCH parameters have been met. For example, the number of maximum HARQ processes may be set at 64 or 32 if the restriction conditions on the PDSCH parameters have been met (e.g., when the actual values of these parameters do not exceed the corresponding maximum). If these restriction conditions are not met, the number of maximum HARQ process IDs may be limited to a lower value (e.g., 16).

In some aspects, the HARQ operation mode may be further based on one or more of: the backhaul latency, or the uplink SINR associated with the network entity. For example, referring to FIG. 8, the HARQ operation mode may be further based on one or more of: the backhaul latency (e.g., the latency on backhaul link 822), or the uplink SINR associated with the network entity (e.g., base station 1004).

In some aspects, the HARQ operation mode may be based on the number of configured PUCCH groups. For example, the first number of maximum HARQ processes may be 16, which is associated with the first HARQ operation mode where two PUCCH groups have been configured, and the second number of maximum HARQ processes may be 64, which is associated with the second HARQ operation mode where one PUCCH group has been configured.

In some aspects, the at least one carrier may be included in the group of carriers for a configured PUCCH group, and the HARQ operation mode may be based on whether a transmission of HARQ feedback for the at least one carrier is on a carrier outside the group of carriers for the configured PUCCH group. For example, referring to FIG. 10, the at least one carrier may be included in the group of carriers for a configured PUCCH group, and the HARQ operation mode may be based on the HARQ feedback condition (e.g., the transmission path of the HARQ feedback). For example, the switch indication may indicate a change between a first transmission of HARQ feedback for the at least one carrier on a carrier outside the group of carriers for the configured PUCCH group (e.g., an LB CC or FR1 CC outside the group of HB CCs or FR2 CCs) and a second transmission of the HARQ feedback for the at least one carrier within the configured PUCCH group.

In some aspects, the HARQ operation mode may be based on the PDSCH restriction condition, and the PDSCH restriction condition may be based on restriction parameters. The restriction parameters may include one or more of: the maximum TB size, the maximum MCS, the maximum code rate, the maximum modulation order, the maximum bandwidth, the maximum number of layers, or the maximum number of carriers. For example, the HARQ operation mode may be associated with whether restriction conditions on the PDSCH parameters have been met. For example, the number of maximum HARQ processes may be set at 64 or 32 if the restriction conditions on the PDSCH parameters have been met (e.g., when the actual values of these parameters do not exceed the corresponding maximum). If these restriction conditions are not met, the number of maximum HARQ process IDs may be limited to a lower value (e.g., 16).

In some aspects, the maximum number of HARQ processes may be different than an initial maximum number of HARQ processes for the UE. For example, the maximum number of HARQ processes may be 16, which is associated with the first HARQ operation mode where two PUCCH groups have been configured, and the initial maximum number of HARQ processes may be 64, which is associated with the second HARQ operation mode where one PUCCH group has been configured.

In some aspects, at 1402, the network entity may receive, from the UE, a UE capability indicative of a set of supported maximum numbers of HARQ processes respectively corresponding to a set of PDSCH restriction conditions. For example, referring to FIG. 10, the network entity (e.g., base station 1004) may, at 1006, receive, from the UE 1002, a UE capability indicative of a set of supported maximum numbers of HARQ processes respectively corresponding to a set of PDSCH restriction conditions. In some aspects, 1402 may be performed by the HARQ component 199.

In some aspects, the set of PDSCH restriction conditions may correspond to a set of values for the restriction parameters. For example, the set of PDSCH restriction conditions may correspond to a set of values for the restriction parameters, and these values may include the TB size, the MCS, which may include the code rate and the modulation order, the BW, the number of layers, and the number of CCs, among others.

In some aspects, at 1410, the network entity may receive, from the UE, a HARQ-ACK in response to the indication, and the maximum number of the HARQ processes may be applied at the UE at a time interval after the HARQ-ACK. For example, referring to FIG. 10, the network entity (e.g., base station 1004) may, at 1018, receive, from the UE 1002, a HARQ-ACK in response to the indication, and the maximum number of the HARQ processes may be applied at the UE at a time interval (e.g., time interval 906, 956) after the HARQ-ACK (e.g., HARQ-ACK 904, 954). In some aspects, 1410 may be performed by the HARQ component 199.

In some aspects, at 1408, the network entity may transmit, to the UE, an RRC configuration for the time interval. For example, referring to FIG. 10, the network entity (e.g., base station 1004) may, at 1016, transmit, to the UE 1002, an RRC configuration for the time interval (e.g., the time interval 906, 956). In some aspects, 1408 may be performed by the HARQ component 199.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to adjust, based on a HARQ operation mode, a maximum number of HARQ processes for at least one carrier in a group of carriers from a first number to a second number, where the HARQ operation mode is based on one or more of: a number of configured PUCCH groups, a PUCCH condition associated with the number of configured PUCCH groups, a HARQ feedback condition, a PDSCH restriction condition, or an indication in one or more of a MAC-CE or DCI; and communicate with a network entity based on the second number of the maximum number of HARQ processes. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for adjusting, based on a HARQ operation mode, a maximum number of HARQ processes for at least one carrier in a group of carriers from a first number to a second number, where the HARQ operation mode is based on one or more of: a number of configured PUCCH groups, a PUCCH condition associated with the number of configured PUCCH groups, a HARQ feedback condition, a PDSCH restriction condition, or an indication in one or more of a MAC-CE or DCI; and means for communicating with a network entity based on the second number of the maximum number of HARQ processes. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

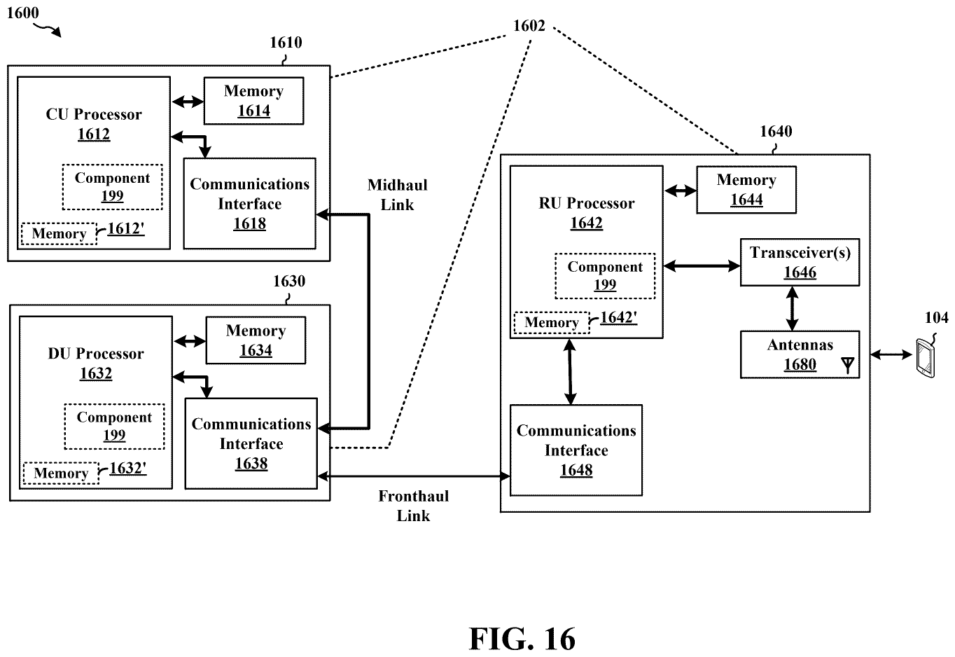

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to configure a UE to transmit HARQ feedback based on a HARQ operation mode for at least one carrier in one or more configured PUCCH group; and transmit, in a MAC-CE or DCI, an indication indicative of a maximum number of HARQ processes for the UE. The component 199 may be further configured to perform any of the aspects described in connection with the flowcharts in FIG. 13 and FIG. 14, and/or performed by the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for configuring a UE to transmit HARQ feedback based on a HARQ operation mode for at least one carrier in one or more configured PUCCH group; and means for transmitting, in a MAC-CE or DCI, an indication indicative of a maximum number of HARQ processes for the UE. The network entity 1602 may further include means for performing any of the aspects described in connection with the flowcharts in FIG. 13 and FIG. 14, and/or aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include adjusting, based on a HARQ operation mode, a maximum number of HARQ processes for at least one carrier in a group of carriers from a first number to a second number, where the HARQ operation mode is based on one or more of: a number of configured PUCCH groups, a PUCCH condition associated with the number of configured PUCCH groups, a HARQ feedback condition, a PDSCH restriction condition, or an indication in one or more of a MAC-CE or DCI; and communicating with a network entity based on the second number of the maximum number of HARQ processes. By enabling conditional increases in the number of HARQ process based on various network conditions and configurations, such as uplink SINR and backhaul latency, the methods enhance flexibility and efficiency in managing uplink communications, thereby improving the reliability in wireless communications. Additionally, by allowing dynamic adjustment of the number of HARQ processes according to the specific PUCCH configuration (e.g., one or two configured PUCCH groups), the methods reduce the feedback latency and increase downlink throughput.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes adjusting, based on a hybrid automatic repeat request (HARQ) operation mode, a maximum number of HARQ processes for at least one carrier in a group of carriers from a first number to a second number, wherein the HARQ operation mode is based on one or more of: a number of configured physical uplink control channel (PUCCH) groups, a PUCCH condition associated with the number of configured PUCCH groups, a HARQ feedback condition, a physical downlink shared channel (PDSCH) restriction condition, or an indication in one or more of a medium access control (MAC)-control element (MAC-CE) or downlink control information (DCI); and communicating, based on the second number of the maximum number of HARQ processes, with a network entity.
Aspect 2 is the method of aspect 1, wherein adjustment of the maximum number of HARQ processes is based on the PUCCH condition, wherein the PUCCH condition includes the number of configured PUCCH groups being one, and wherein adjusting the maximum number of HARQ processes comprises: increasing, in response to the PUCCH condition being met, the maximum number of HARQ processes from the first number to the second number.
Aspect 3 is the method of any of aspects 1 to 2, wherein the first number of maximum HARQ process are defined in a wireless standard for a first HARQ operation mode and the second number of maximum HARQ process are defined in the wireless standard for the second HARQ operation mode.
Aspect 4 is the method of any of aspects 1 to 3, wherein adjusting the maximum number of HARQ processes includes receiving a switch indication to switch between a first HARQ operation mode and a second HARQ operation mode; and switching the maximum number of HARQ processes between the first number and the second number based on the switch in the HARQ operation mode between the first HARQ operation mode and the second HARQ operation mode.
Aspect 5 is the method of aspect 4, where the method further includes receiving, prior to the switch indication, a configuration of the first number of maximum HARQ process associated with the first HARQ operation mode and the second number of maximum HARQ process associated with the second HARQ operation mode.
Aspect 6 is the method of aspect 4, wherein the switch indication indicates a change between multiple configured PUCCH groups and a single configured PUCCH group.
Aspect 7 is the method of aspect 4, wherein the at least one carrier is comprised in the group of carriers for a configured PUCCH group, and the HARQ operation mode is based on the HARQ feedback condition, wherein the switch indication indicates a change between a first transmission of HARQ feedback for the at least one carrier on a carrier outside the group of carriers for the configured PUCCH group and a second transmission of the HARQ feedback for the at least one carrier within the configured PUCCH group.
Aspect 8 is the method of any of aspects 1 to 7, wherein the HARQ operation mode is based on the PDSCH restriction condition that includes one or more of: a maximum TB size, a maximum MCS, a maximum code rate, a maximum modulation order, a maximum bandwidth, a maximum number of layers, or a maximum number of carriers.
Aspect 9 is the method of aspect 8, wherein adjusting the maximum number of HARQ processes comprises increasing, in response to the PDSCH restriction condition being met, the maximum number of HARQ processes from the first number to the second number.
Aspect 10 is the method of any of aspects 1 to 9, wherein the first number is 16, and the second number is 32 or 64.
Aspect 11 is the method of aspect 8, where the method further includes indicating, to the network entity, support for the maximum number of HARQ processes corresponding to at least one PDSCH restriction condition.
Aspect 12 is the method of aspect 1, where the method further includes receiving the indication, from the network entity, in the MAC-CE or the DCI, wherein the indication indicates a maximum number of HARQ processes, and wherein adjusting the maximum number of HARQ processes includes adjusting the maximum number of HARQ processes based on the indication in the MAC-CE or the DCI.
Aspect 13 is the method of aspect 12, where the method further includes transmitting, to the network entity, a HARQ-ACK in response to the indication, wherein the adjustment is applied at a time interval after the HARQ-ACK.
Aspect 14 is the method of aspect 13, wherein the method further includes indicating, to the network entity, the time interval.
Aspect 15 is the method of aspect 13, wherein the method further includes receiving, from the network entity, a radio resource control (RRC) configuration for the time interval.
Aspect 16 is the method of aspect 12, wherein the indication of the maximum number of HARQ processes is comprised in the DCI, and wherein the method further comprises: maintaining the maximum number of HARQ processes until a second DCI indication indicating a different maximum number of HARQ processes.
Aspect 17 is the method of aspect 12, where the method further includes flushing, in response to the indication of the maximum number of HARQ processes, a HARQ buffer for all HARQ process IDs.
Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.
Aspect 19 is an apparatus for wireless communication at a UE, comprising: at least one memory; and at least one processor coupled to the at least one memory and, where the at least one processor, individually or in any combination, is configured to perform the method of any of aspects 1-17.
Aspect 20 is the apparatus for wireless communication at a UE, comprising means for performing each step in the method of any of aspects 1-17.
Aspect 21 is an apparatus of any of aspects 18-20, further comprising a transceiver configured to receive or to transmit in association with the method of any of aspects 1-17.
Aspect 22 is a computer-readable medium (e.g., a non-transitory computer-readable medium) storing computer executable code at a UE, the code when executed by at least one processor causes the at least one processor to, individually or in any combination, perform the method of any of aspects 1-17.
Aspect 23 is a method of wireless communication at a network entity. The method includes configuring a user equipment (UE) to transmit hybrid automatic repeat request (HARQ) feedback based on a HARQ operation mode for at least one carrier in one or more configured physical uplink control channel (PUCCH) group; and transmitting, in a medium access control (MAC)-control element (MAC-CE) or downlink control information (DCI), an indication indicative of a maximum number of HARQ processes for the UE.
Aspect 24 is the method of aspect 23, wherein the maximum number of HARQ processes is based on the HARQ operation mode, and wherein the HARQ operation mode is based on one or more of: a number of configured PUCCH groups, a PUCCH condition associated with the number of configured PUCCH groups, a HARQ feedback condition, or a physical downlink shared channel (PDSCH) restriction condition.
Aspect 25 is the method of aspect 24, wherein the HARQ operation mode is further based on one or more of: a backhaul latency, or an uplink signal-to-interference-plus-noise ratio (SINR) associated with the network entity.
Aspect 26 is the method of aspect 24, wherein the HARQ operation mode is based on the number of configured PUCCH groups.
Aspect 27 is the method of aspect 24, wherein the at least one carrier is comprised in the group of carriers for a configured PUCCH group, and the HARQ operation mode is based on whether a transmission of HARQ feedback for the at least one carrier is on a carrier outside the group of carriers for the configured PUCCH group.
Aspect 28 is the method of any of aspects 24 to 27, wherein the HARQ operation mode is based on the PDSCH restriction condition, wherein the PDSCH restriction condition is based on restriction parameters, wherein the restriction parameters include one or more of: a maximum TB size, a maximum MCS, a maximum code rate, a maximum modulation order, a maximum bandwidth, a maximum number of layers, or a maximum number of carriers.
Aspect 29 is the method of aspect 28, wherein the maximum number of HARQ processes is different than an initial maximum number of HARQ processes for the UE.
Aspect 30 is the method of any of aspects 28 to 29, wherein the method further includes: receiving, from the UE, a UE capability indicative of a set of supported maximum numbers of HARQ processes respectively corresponding to a set of PDSCH restriction conditions.
Aspect 31 is the method of aspect 30, wherein the set of PDSCH restriction conditions corresponds to a set of values for the restriction parameters.
Aspect 32 is the method of any of aspects 24 to 31, where the method further includes receiving, from the UE, a HARQ-ACK in response to the indication, wherein the maximum number of the HARQ processes is applied at the UE at a time interval after the HARQ-ACK.
Aspect 33 is the method of aspect 32, where the method further includes transmitting, to the UE, a radio resource control (RRC) configuration for the time interval.
Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 23-33.
Aspect 35 is an apparatus for wireless communication at a network entity, comprising: at least one memory; and at least one processor coupled to the at least one memory and, where the at least one processor, individually or in any combination, is configured to perform the method of any of aspects 23-33.
Aspect 36 is the apparatus for wireless communication at a network entity, comprising means for performing each step in the method of any of aspects 23-33.
Aspect 37 is an apparatus of any of aspects 34-36, further comprising a transceiver configured to receive or to transmit in association with the method of any of aspects 23-33.
Aspect 38 is a computer-readable medium (e.g., a non-transitory computer-readable medium) storing computer executable code at a network entity, the code when executed by at least one processor causes the at least one processor to, individually or in any combination, perform the method of any of aspects 23-33.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
adjust, based on a hybrid automatic repeat request (HARQ) operation mode, a maximum number of HARQ processes for at least one carrier in a group of carriers from a first number to a second number, wherein the HARQ operation mode is based on one or more of:
a number of configured physical uplink control channel (PUCCH) groups,
a PUCCH condition associated with the number of configured PUCCH groups,
a HARQ feedback condition,
a physical downlink shared channel (PDSCH) restriction condition, or
an indication in one or more of a medium access control (MAC)-control element (MAC-CE) or downlink control information (DCI); and
communicate, based on the second number of the maximum number of HARQ processes, with a network entity.

2. The apparatus of claim 1, further comprising a transceiver coupled to the at least one processor, wherein to communicate with the network entity, the at least one processor, individually or in any combination, is configured to communicate with the network entity via the transceiver, wherein adjustment of the maximum number of HARQ processes is based on the PUCCH condition, and the PUCCH condition includes the number of configured PUCCH groups being one, and wherein to adjust the maximum number of HARQ processes, the at least one processor, individually or in any combination, is configured to cause the UE to:
increase, in response to the PUCCH condition being met, the maximum number of HARQ processes from the first number to the second number.

3. The apparatus of claim 1, wherein the first number of maximum HARQ process is defined in a wireless standard for a first HARQ operation mode and the second number of maximum HARQ process is defined in the wireless standard for the second HARQ operation mode.

4. The apparatus of claim 1, wherein to adjust the maximum number of HARQ processes, the at least one processor, individually or in any combination, is configured to cause the UE to:
receive a switch indication to switch between a first HARQ operation mode and a second HARQ operation mode; and
switch the maximum number of HARQ processes between the first number and the second number based on the switch in the HARQ operation mode between the first HARQ operation mode and the second HARQ operation mode.

5. The apparatus of claim 4, wherein the at least one processor, individually or in any combination, is configured to cause the UE to:
receive, prior to the switch indication, a configuration of the first number of maximum HARQ process associated with the first HARQ operation mode and the second number of maximum HARQ process associated with the second HARQ operation mode.

6. The apparatus of claim 4, wherein the switch indication indicates a change between multiple configured PUCCH groups and a single configured PUCCH group.

7. The apparatus of claim 4, wherein the at least one carrier is comprised in the group of carriers for a configured PUCCH group, and the HARQ operation mode is based on the HARQ feedback condition, wherein the switch indication indicates a change between a first transmission of HARQ feedback for the at least one carrier on a carrier outside the group of carriers for the configured PUCCH group and a second transmission of the HARQ feedback for the at least one carrier within the configured PUCCH group.

8. The apparatus of claim 1, wherein the HARQ operation mode is based on the PDSCH restriction condition that includes one or more of:
a maximum transport block (TB) size,
a maximum modulation and coding scheme (MCS),
a maximum code rate,
a maximum modulation order,
a maximum bandwidth,
a maximum number of layers, or
a maximum number of carriers.

9. The apparatus of claim 8, wherein to adjust the maximum number of HARQ processes, the at least one processor, individually or in any combination, is configured to cause the UE to:
increase, in response to the PDSCH restriction condition being met, the maximum number of HARQ processes from the first number to the second number.

10. The apparatus of claim 1, wherein the first number is 16, and the second number is 32 or 64.

11. The apparatus of claim 8, wherein the at least one processor, individually or in any combination, is configured to cause the UE to:
indicate, to the network entity, support for the maximum number of HARQ processes corresponding to at least one PDSCH restriction condition.

12. The apparatus of claim 1, wherein the at least one processor, individually or in any combination, is configured to cause the UE to:
receive the indication, from the network entity, in the MAC-CE or the DCI, wherein the indication indicates the maximum number of HARQ processes, and wherein to adjust the maximum number of HARQ processes, the at least one processor, individually or in any combination, is configured to cause the UE to:
adjust the maximum number of HARQ processes based on the indication in the MAC-CE or the DCI.

13. The apparatus of claim 12, wherein the at least one processor, individually or in any combination, is configured to cause the UE to:
transmit, to the network entity, a HARQ-ACK in response to the indication, wherein the adjustment is applied at a time interval after the HARQ-ACK.

14. The apparatus of claim 13, wherein the at least one processor, individually or in any combination, is configured to cause the UE to:
indicate, to the network entity, the time interval.

15. The apparatus of claim 13, wherein the at least one processor, individually or in any combination, is configured to cause the UE to:
receive, from the network entity, a radio resource control (RRC) configuration for the time interval.

16. The apparatus of claim 12, wherein the indication of the maximum number of HARQ processes is comprised in the DCI, and wherein the at least one processor, individually or in any combination, is further configured to cause the UE to:
maintain the maximum number of HARQ processes until a second DCI indication indicating a different maximum number of HARQ processes.

17. The apparatus of claim 12, wherein the at least one processor, individually or in any combination, is configured to cause the UE to:
flush, in response to the indication of the maximum number of HARQ processes, a HARQ buffer for all HARQ process IDs.

18. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
configure a user equipment (UE) to transmit hybrid automatic repeat request (HARQ) feedback based on a HARQ operation mode for at least one carrier in one or more configured physical uplink control channel (PUCCH) group; and
transmit, in a medium access control (MAC)-control element (MAC-CE) or downlink control information (DCI), an indication indicative of a maximum number of HARQ processes for the UE.

19. The apparatus of claim 18, further comprising a transceiver coupled to the at least one processor, wherein to transmit the indication, the at least one processor, individually or in any combination, is configured to cause the network entity to transmit the indication via the transceiver, wherein the maximum number of HARQ processes is based on the HARQ operation mode, and wherein the HARQ operation mode is based on one or more of:
a number of configured PUCCH groups,
a PUCCH condition associated with the number of configured PUCCH groups,
a HARQ feedback condition, or
a physical downlink shared channel (PDSCH) restriction condition.

20. The apparatus of claim 19, wherein the HARQ operation mode is further based on one or more of:
a backhaul latency, or
an uplink signal-to-interference-plus-noise ratio (SINR) associated with the network entity.

21. The apparatus of claim 19, wherein the HARQ operation mode is based on the number of configured PUCCH groups.

22. The apparatus of claim 19, wherein the at least one carrier is comprised in the group of carriers for a configured PUCCH group, and the HARQ operation mode is based on whether a transmission of HARQ feedback for the at least one carrier is on a carrier outside the group of carriers for the configured PUCCH group.

23. The apparatus of claim 19, wherein the HARQ operation mode is based on the PDSCH restriction condition, wherein the PDSCH restriction condition is based on restriction parameters, wherein the restriction parameters include one or more of:
a maximum TB size,
a maximum MCS,
a maximum code rate,
a maximum modulation order,
a maximum bandwidth,
a maximum number of layers, or
a maximum number of carriers.

24. The apparatus of claim 23, wherein the maximum number of HARQ processes is different than an initial maximum number of HARQ processes for the UE.

25. The apparatus of claim 23, wherein the at least one processor, individually or in any combination, is further configured to cause the network entity to:
receive, from the UE, a UE capability indicative of a set of supported maximum numbers of HARQ processes respectively corresponding to a set of PDSCH restriction conditions.

26. The apparatus of claim 25, wherein the set of PDSCH restriction conditions corresponds to a set of values for the restriction parameters.

27. The apparatus of claim 19, wherein the at least one processor, individually or in any combination, is further configured to cause the network entity to:
receive, from the UE, a HARQ-ACK in response to the indication, wherein the maximum number of the HARQ processes is applied at the UE at a time interval after the HARQ-ACK.

28. The apparatus of claim 27, wherein the at least one processor, individually or in any combination, is further configured to cause the network entity to:
transmit, to the UE, a radio resource control (RRC) configuration for the time interval.

29. A method of wireless communication at a user equipment (UE), comprising:
adjusting, based on a hybrid automatic repeat request (HARQ) operation mode, a maximum number of HARQ processes for at least one carrier in a group of carriers from a first number to a second number, wherein the HARQ operation mode is based on one or more of:
a number of configured physical uplink control channel (PUCCH) groups,
a PUCCH condition associated with the number of configured PUCCH groups,
a HARQ feedback condition,
a physical downlink shared channel (PDSCH) restriction condition, or
an indication in one or more of a medium access control (MAC)-control element (MAC-CE) or downlink control information (DCI); and
communicating with a network entity based on the second number of the maximum number of HARQ processes.

30. A method of wireless communication at a network entity, comprising:
configuring a user equipment (UE) to transmit hybrid automatic repeat request (HARQ) feedback based on a HARQ operation mode for at least one carrier in one or more configured physical uplink control channel (PUCCH) group; and
transmitting, in a medium access control (MAC)-control element (MAC-CE) or downlink control information (DCI), an indication indicative of a maximum number of HARQ processes for the UE.
